(19) United States
(12) Patent Application Publication
(10) Pub. No.: US 2014/0082586 A1
(43) Pub. Date: Mar. 20, 2014

(54) APPLICATION DEVELOPMENT SYSTEM AND METHOD FOR OBJECT MODELS AND DATAGRAPHS IN CLIENT-SIDE AND SERVER-SIDE APPLICATIONS

(71) Applicant: FatFractal, Inc., Battleground, WA (US)

(72) Inventor: Gerard Michael Casey, Highland (GB)

(73) Assignee: FatFractal, Inc., Battleground, WA (US)

(21) Appl. No.: 13/962,922

(22) Filed: Aug. 8, 2013

Related U.S. Application Data
(60) Provisional application No. 61/681,565, filed on Aug. 9, 2012.

(51) Int. Cl. G06F 9/44

(52) U.S. Cl. CPC G06F 8/20
USPC 717/104

(57) ABSTRACT

An application development system and method are provided for object models and datagraphs in client-side and server-side applications of a web-based or cloud-based application deployment platform. The system and method are used for representing, persisting, permitting, traversing, querying, manipulating and extending object models and their imputed datagraphs, in applications spanning the client-side and server-side of the web-based or the cloud-based application deployment platform.

### PRIORITY CLAIMS/RELATED APPLICATIONS

This application claims the benefit under 35 USC 119(e) and 120 to U.S. Provisional Patent Application Ser. No. 61/681,565 filed on Aug. 9, 2012 and entitled “Application Development System And Method For Object Models And Datagraphs In Client-Side And Server-Side Applications”, the entirety of which is incorporated herein by reference.

### APPENDICES

Appendix A1 (10 pages) contains a listing of the FatFractal Definition Language, Object Metadata, Queries and Traversals and ACLs and Permissions that are part of the application development system and method.

Appendix A2 (25 pages) contains a FatFractal Server Side API that is part of the application development system and method.

Appendix A3 (51 pages) contains an iOS API that is part of the application development system and method.

Appendix A4 (24 pages) contains an Android API that is part of the application development system and method.

Appendix A5 (30 pages) contains a HTML5/Javascript API that is part of the application development system and method.

Appendices A1-A5 are part of the specification and are incorporated herein by reference.

### FIELD

The disclosure relates generally to an application development system and method that permits application developers to build application server-side backends which represent, persist, assign permissions, traverse, query, manipulate and extend their object models, as well as their imputed datagraphs, on a web- or cloud-based application deployment platform, from any connected client.

### BACKGROUND

Application development systems are well-known and well-understood in the area of developing web applications. As various client-side devices, such as mobile phones and smartphones, have proliferated, application developers have begun to look for application development systems focused on mobile applications (“apps”). Certain cloud based technologies, such as Infrastructure as a Service (IaaS) and Platform as a Service (PaaS) technologies, have made it attractive for developers to create applications that connect to the cloud, whether for use as an application accessed via a web browser (“web-app”), an application executing on a client-side device (“mobile app”, “tablet app” or “desktop app”), or any other kind of device (collectively, “connected devices”). Currently there are significant limitations in the development systems and platforms for coding applications that make use of backends to be accessed via connected devices: (a) connected devices use different programming languages for the client, including Objective-C, JavaScript, Java and others; (b) backends use different programming languages as well such as Ruby, Python and others which must be used to code a backend for the web or cloud; c) current technologies for backend business logic and data storage do not generally scale well, depending on the size of the data and the underlying architecture, increasing the burden for application developers to manage data modeling; d) modeling on the client-side, for any significantly complex object model, is difficult and time-consuming; e) client-side object models must be reflected on the backend which requires significant additional programming time in creating schema configurations and boilerplate code; f) creating relationships between various objects in the object model is inefficient, particularly if change are introduced after the initial models have been created; g) querying the backend in a web or cloud environment can be difficult to code in an efficient manner as there are often limitations on nesting queries or on the manner in which queries can be processed on the backend; and h) creating and managing an authentication and permissions model for an application requires an effort largely recreated for each application.

These limitations motivate the development of a new application development approach. It is desirable to have an application development system, designed for a web-based or a cloud-based platform, that makes it easier and more efficient for developers to 1) create pure object models on the client-side in any language they wish and persist them to any kind of datastore; 2) persist those object models without requiring the backend be explicitly coded or schemas explicitly defined on the server-side; 3) get back from the system a datagraph, imputed from the object models, whereby that datagraph can be traversed and queried in ways a developer may not have specified in the code; 4) connect data models, across arbitrarily large sets of data, allowing for any number of or kind of relationships between collections and objects without impacting the original object models and without the overhead of creating the equivalent of traditional “join tables” in an RDBMS; 5) have inherent support for “users” and the ability to set default ACLs and change permissions of users or groups on collections, objects and members as declarative defaults and at runtime, dynamically altering the datagraph traversable by those users or groups; and 6) query and traverse the datagraph with a flexible, easy-to-use query/traversal language that takes into account both permissions and authorization at runtime.

None of the currently available application development systems provide such capabilities as described above. There is also a need for an application development system that allows developers to leverage this functionality in creating applications and cloud-based services for connected devices in horizontal segments (including but not limited to social networking, games and media) as well as vertical segments (including but not limited to financial services, telecom, non-profit, e-commerce, consumer goods and manufacturing) which is not provided by current systems.

Furthermore, as such connected applications are deployed across networks, infrastructures and platforms, there are significant concerns in optimizing the costs of operations, maintenance, configuration, storage and performance associated with such applications, particularly as their usage grows. For example, it is desirable to generate code on an application development system that optimizes the performance, footprint and data management for the end-to-end journey from client-side to server-side, including across the network, by allowing the creation of efficient, clean code by the developer, by offloading CPU intensive code to the backend, by minimizing the number of roundtrips of data across the wire and by minimizing the amount of data sent across the wire. These optimizations, in turn, will reduce costs, including the cost of storage, hardware, bandwidth, configuration and management on infrastructure services.

Further, given the requirement for quick, responsive applications on connected devices, it is important that an application development system offer the most performance functionality in querying the datagraph, in caching data, in providing lazy loading options, in handling events related to the datagraph on the backend whenever possible, in providing an integrated permissions model for the datagraph and in handling boilerplate and configuration issues outside the client code. An application development system that optimizes for responsiveness whether in a web- or cloud-based environment, is required in many, if not most modern applications.

On contemporary web-based and cloud-based platforms, the data storage method can significantly impact scalability of an application based on the way that those storage methods process relationships between objects. Application development systems require functionality to represent, store and manage application data to eliminate these problems and ensure a scalable, responsive application that satisfies the application developer's end-users. The application development system and method described below achieves these goals and it is to this end that the application development system and method are directed.

### BRIEF DESCRIPTION OF THE DRAWINGS

FIG. 1A illustrates an example of an application environment in which an application development system may be used;

FIG. 1B illustrates an application development system;

FIG. 2 illustrates an exemplary implementation of a platform on which an application development system is deployed;

FIG. 3 illustrates an exemplary implementation of a platform engine on the backend of an application development system where containers, such as an embodiment of the invention, NoServer Module, runs code created by a developer;

FIG. 4 illustrates the details of an embodiment of the invention, NoServer Module and the flow of an application through the Module;

FIG. 5 illustrates an example of a graph of a conceptual data model for a sample application called ‘Amongst Friends’;

FIG. 6 illustrates an RDBMS approach to an object model from the data model in FIG. 5;

FIG. 6a illustrates the explicit object model to be coded from the example in FIG. 5;

FIG. 7 illustrates the datagraph derived from both the explicit object model from FIG. 7 and the implicit model determined by an embodiment of the invention;

FIG. 8 illustrates the interfaces from an exemplary implementation of the object model in Objective-C as described in FIG. 6;

FIG. 9 illustrates the backend state, in FFDL (“fiddle”), resulting from the running of the application described in FIG. 7;

FIG. 10 illustrates the detailed representation of the formats and data as stored by an embodiment of the invention for the sample application called ‘Amongst Friends’ first described in FIG. 5;

FIG. 11 illustrates a continuation of the detailed representation of the formats and data from FIG. 10;

FIG. 12 illustrates a continuation of the detailed representation of the formats and data from FIG. 11;

FIG. 13 illustrates the addition of a PERMIT command to the metadata description from the sample application ‘Amongst Friends’, a change to the file depicted in FIG. 8;

FIG. 14 illustrates the resulting datagraph from the addition of the PERMIT command in FIG. 13;

FIG. 15 illustrates the resulting datagraph from the addition of client-side code which declaratively changes permissions at runtime, to the example in FIG. 14;

FIG. 16 illustrates the resulting datagraph from the addition of client-side code which moves a user to a group with differing permissions at runtime, to the example in FIG. 15;

FIG. 17 illustrates an example of a graph of a conceptual data model for a sample application called ‘The Simons’;

FIG. 18 illustrates the use of an embodiment of the query language request URI against the graph from FIG. 17;

FIG. 19 illustrates the use of a traversal of the datagraph implied from the sample application from FIG. 17;

FIG. 20 illustrates the use of a query back reference; and

FIG. 21 illustrates the use of other queries using the data model.

### DETAILED DESCRIPTION OF ONE OR MORE EMBODIMENTS

The disclosure is particularly applicable to public, cloud-based application deployment platforms, where client-side applications are built for one or more connected devices such as mobile phones, web browsers, tablets or other network-accessible devices and where developers require an application development system both to create the client-side applications and to connect those applications to a full-featured backend in the cloud, deriving and manipulating a datagraph from a developer's object model(s). It will be appreciated, however, that the application development system and method may be applied to other platforms, to private clouds, to hybrid clouds and to any connected device where a developer requires the ability to represent, persist, permit, traverse, query, manipulate and extend object models and to manipulate the datagraphs imputed from those models.

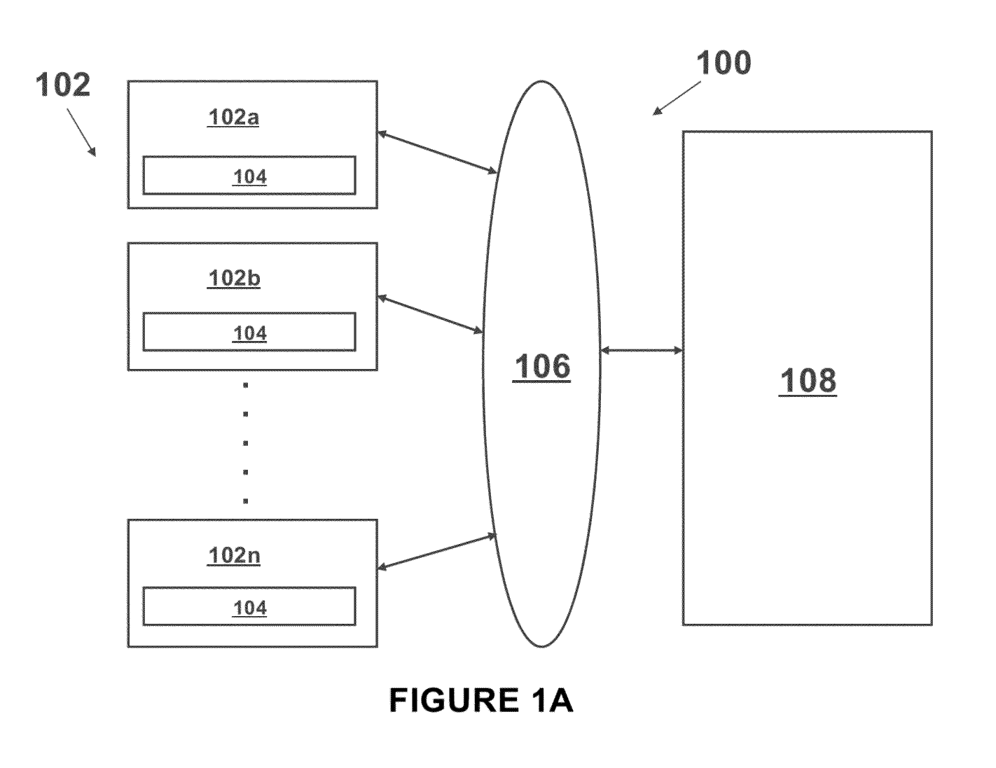

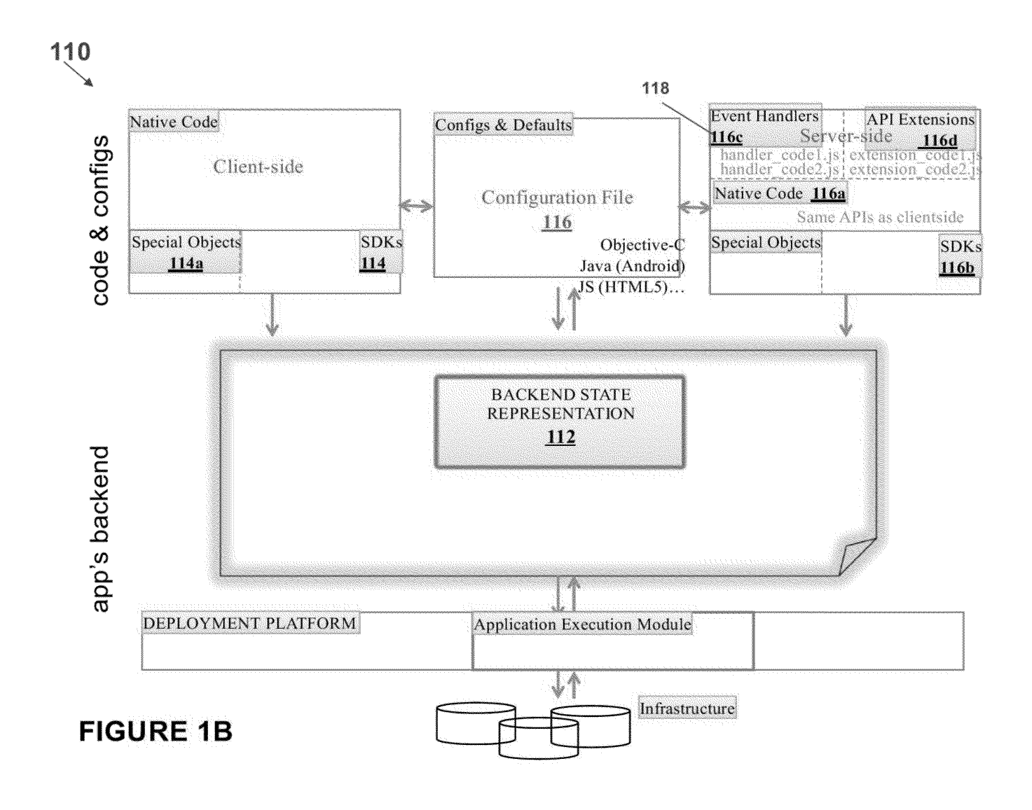

FIG. 1A illustrates an example of an application environment 100 in which an application development system may be used. The application environment 100 may include one or more connected devices 102, such as 102a, 102b, . . . , 102n as shown in the example in FIG. 1A, that can connect to a link 106, such as a computer network, the cloud, the internet, etc. to a backend system 108 that may be implemented as a web system or as a system hosted in the cloud and the like. The backend system 108 may be implemented using one or more computing resources (such as one or more server computers in a web system or one or more cloud computing resources in a cloud hosted system) wherein each computing resource is a processor based system that may store one or more applications or modules that each has a plurality of lines of computer code and the one or more applications or modules may be executed by the processor of the computing resource.

Each connected device 102 may be a processing unit based device that has one or more processing units, memory, a display and connectivity so that is can connect to, communicate with and interact with the backend system 108. For example, each connected device may be any one of mobile phones, smartphones, web browsers, computers, tablets or other network-capable devices. Each connected device may have an application 104 that is executed by the processing unit of the connected device wherein the application may be a browser application to execute a web app or a mobile application resident on the connected device, or any other such application on any kind of connected device. The application development system and method allows client-side applications on the connected devices to be created that can be connected to a full-featured backend in the cloud, deriving, manipulating and providing unique access to a datagraph from a developer's object models as will now be described in more detail.

FIG. 1B illustrates an application development system 110 in which a developer creates and configures code, and deploys the application, configurations and defaults as well as additional code or script files to the app's backend which will be hosted on some infrastructure which may be on a specific server or virtualized in the cloud. A backend state representation 112 may include all the meta-data related to that running application and both the frontend and the backend can understand and manipulate the meta-data. Further, in an exemplary embodiment, the meta-data fully describes and controls the data structures, data collections, configurations, default permissions and application services without any backend coding required. This then operates as a meta-data driven system that removes the need for boilerplate code required to create a backend. The application itself may run in a container on the backend designed to execute or secure from the underlying platform or services all of the code, configurations, events, queries, etc. of the application and information and data will pass back and forth between the frontend and the backend as necessary as the application executes via a fully formed REST API. In an exemplary embodiment, on the client-side, the application development system may provide SDKs 114 for Objective-C, Java, C++ and Javascript/HTML5, which the developer may use to easily access the application's backend from the client code. Exposed in those SDKs may be special objects 114a, such as those for users and groups in an application, that may provide application developers with features, such as automating the authentication for users and querying or settings permissions and ACLs for such users and groups on objects, as part of the application's datagraph. A developer may also access and write a configuration file 116 to set defaults that an application may require when the application starts up. Further, in an exemplary embodiment, the configuration file will include default access control definitions for persisted data. In addition, the developer may create server-side code 118, using server-side languages 116a and SDKs 116b that support the same application programming interfaces (APIs) as the client-side via SDKs, for example, provided for JavaScript (server-side) and Ruby. The server-side code may be used to code event handlers 116c and to extend the API 116d of the developer's application, important parts of the developer's “toolkit” for the development of a such a web- or cloud-based application.

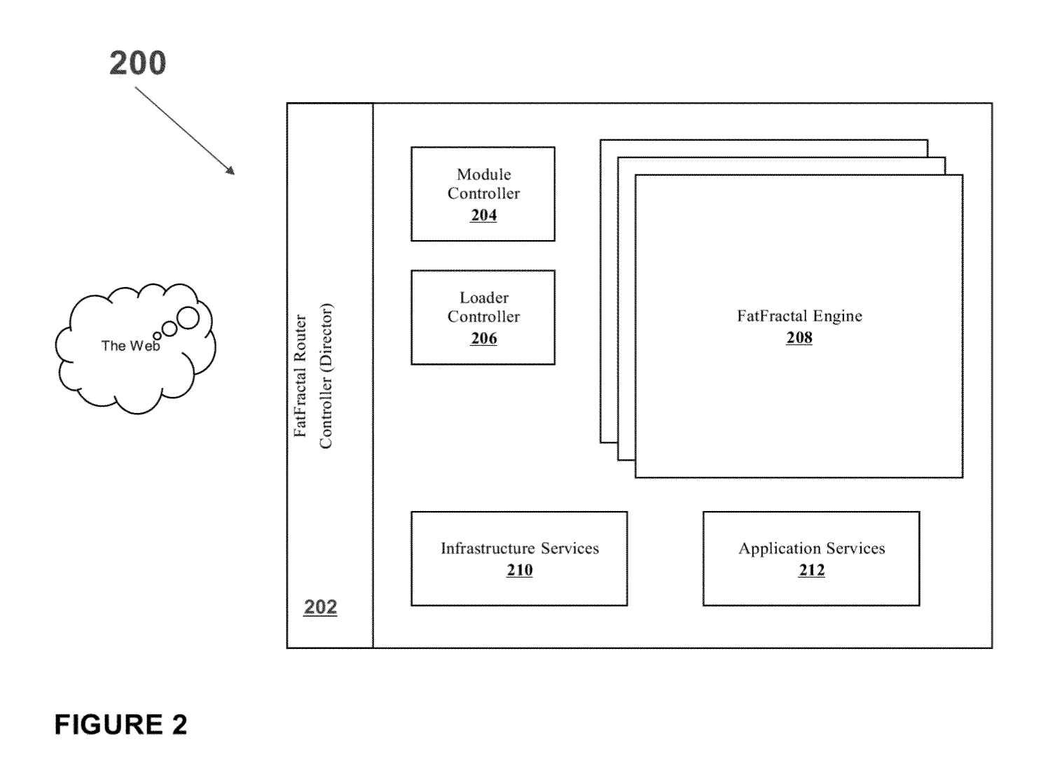

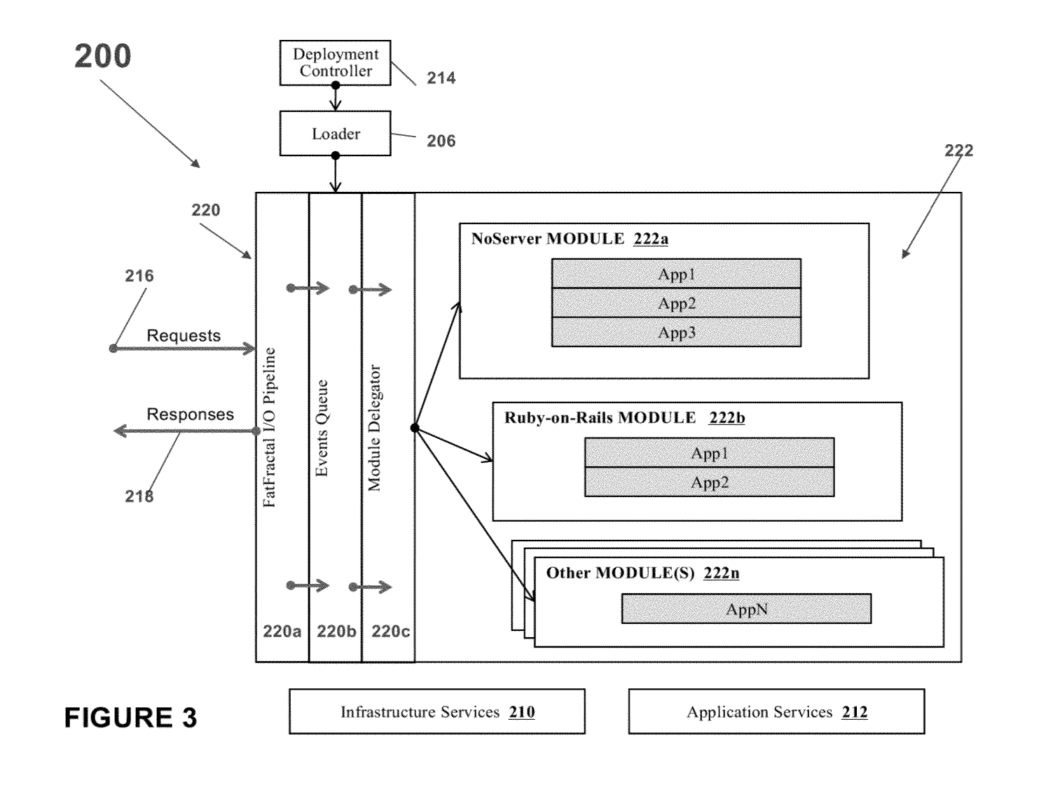

FIG. 2 and FIG. 3 illustrate an environment in which the system might be incorporated, in this example, within the context of a cloud-based Platform as a Service (PaaS) in which the computing resources of the platform elements shown in FIGS. 2 and 3 are implemented using computer resources in the cloud. FIG. 2 shows a high level view of an engine-based platform 200 on which the system runs and on which the underlying data model for a developer's application is managed. The engine-based platform may have a router controller/director 202 that directs incoming and outgoing requests and data, a module controller 204 that specifies the language or environment to which those requests and data should be directed to, a loader controller 206 that load balances across requirements for platform resources and an engine 208 whose function and operation is described in more detail below. In this exemplary embodiment, the platform 200 also may have infrastructure services 210 and application services 212 that may be accessed by the system through platform APIs, thus abstracting those services and allowing the system to be utilized with different data stores, for example, NoSQL or MySQL, and to be hosted on different infrastructures, for example, Amazon, Rackspace or a companies' own data center.

FIG. 3 illustrates more details on how one or more requests 216 are passed in and one or more responses 218 out via the host platform and distributed to the applications in conjunction with that platform's own specifications. The system/platform 200 has a deployment controller 214 that controls the deployment of each application on the platform and also includes the system's mechanism for authentication and managing desktop run time environments for developers. The platform has one or more input modules 220, such as an input/output (I/O) pipeline 220a that determines the appropriate routing for the requests that come into the system, an event queue 220b that registers events to be processed by the system and a module delegator 220c that determines the modules/containers it requires to service those requests. In the event that the engine does not already have the required module, it makes that request to the module controller 204, a repository of all modules available to the system, which fulfills the module delegator's requirements. In the example in FIG. 3, the platform may have one or more modules/containers 222, such as NoServer module 222a, a Ruby-on-rails module 222b and other modules 222n. Each of the modules may have one or more applications (App1, App2, App3, etc.) that execute within a particular module based on the language, etc. used by the application. The FatFractal NoServer Module (“NoServer”) 222a is an exemplary implementation where applications run in containers that are calling on and receiving services from the host platform, such as HTTP requests and where the NoServer Module processes the configuration file, runs the server-side code, processes events and custom code, implements permission-based ACLs and takes advantage of the PaaS APIs, as required and allowed, to meet the needs of the application.

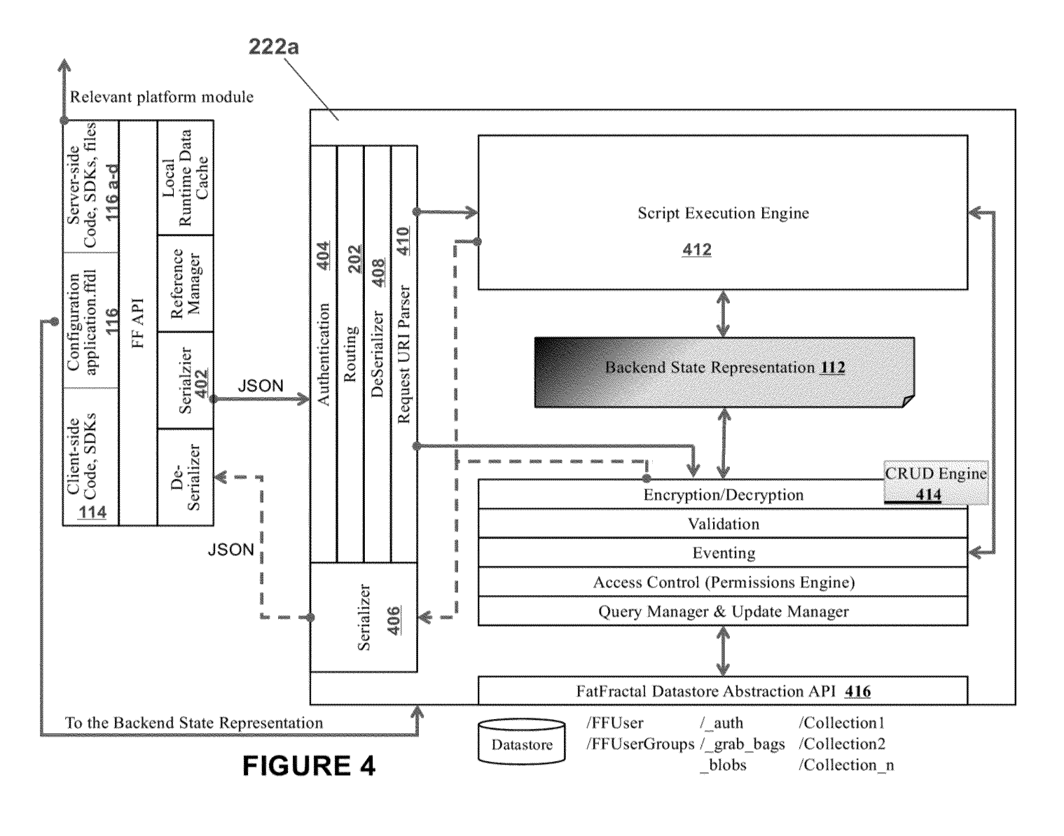

FIG. 4 illustrates in detail the architecture and application flow through an exemplary implementation NoServer module 222a. A practitioner skilled in the art will understand that a system and method for involving a developer's data model for a web- or cloud-based application, must be designed to optimize and facilitate the path through the various platform and technology components that comprise such a system. In the NoServer implementation, the developer may define the data model by writing native code 114 in a programming language, such as Objective-C, Javascript or Java, that may describe an application object model and its associated classes and members using all of the mechanisms provided by that programming language (and expressly not limited to dictionaries and hash maps), used in conjunction with a system's client libraries of functions and methods (SDKs) and transmitting such descriptions, definitions and data to the application's backend 222a. Such a system may not always require an explicit definition of the object model be re-duplicated on the backend (normally called a “schema”), but may derive such schema and other information from interactions with the client-side code. Such a system may also allow a developer to manipulate the object model and its associated classes, members and collections based on a configurable “learn mode” as specified in a configuration file 116 for that application (for the complete set of options the developer has in “learn mode” detailed in Appendix A1). In addition to coding the object models on the client-side, in this exemplary implementation, the developer may also use the FatFractal Definition Language (“FFDL”), a mark up language written to an applications' configuration file 116, to set defaults, create object-type schemas, create collections, set default ACLs and permissions, define & link events to event handlers, define & link server extensions, schedule tasks, and establish aliases (a complete set of FFDL commands and their syntax is available in the Appendix A1). In this exemplary implementation, the configuration file 116 markup language is described in FFDL, however, a practitioner of the art will understand that such a configuration file could be represented in any markup language such as plain text or extensible markup language (XML). In creating server-side code for use in event handlers and API extensions using custom code, a developer might also take advantage of the same SDKs and the same “learn mode” as on the client-side, in a variety of backend programming languages, including but not limited to JavaScript server-side 116a-d.

In the NoServer exemplary implementation, client-side 114 and server-side SDKs 116a-d may provide developers with functionality that is not available as a standard part of native code libraries and functionality, but that is a feature of the system, such as system user objects, system group objects, other system objects, object-types and methods or functions to create, manipulate, authorize, permit and manage the same (all of which will be described in detail). The FatFractal Platform may also support, through its API, additional specifications and functions such as resource referencing and queries (via URLs) that may be documented for the developer. The client-side and server-side SDK may contain a serializer 402 to encapsulate the object model into a form that can be exchanged over a network between the client and the backend. The serializer should be able to translate each object and its members, including those system objects and members which are not part of the native code libraries and which form part of the platform to an appropriate form for transmission over a network.

In the NoServer exemplary implementation, the complete set of information describing the developer's application and the object model for that application is read by the NoServer Module. The application.ffdl configuration is read by the Backend 222a where the system will set the appropriate default and configurations as the application starts up and server-side code and scripts are delivered to the relevant FatFractal platform modules responsible for that code.

In an exemplary implementation, a serializer 406 converts the data which is to be exchanged to JSON, however, a practitioner of the art will understand that such a serializer could convert it to one or any combination of markup languages such as action message format (AMF), extensible markup language (XML), etc. Upon receipt by the NoServer module, any data presented from the client-side code, including the JSON-encapsulated object model for the application, will be validated and routed as appropriate: 1) in addition, the request may include session information that results from user authentication, 2) the JSON-encapsulated object model will be deserialized by a deserializer 408 and configured into the component constituents understood by the NoServer Module; 3) a request URIs will be parsed by a parser 410; and 4) depending on the data received, code may be executed on one or more script execution engines 412.

At this point, the further representation, persistence and management of the application's object model in this embodiment depends on: a) the defaults, commands and configurations contained in application.ffdl and viewable as metadata in the Backend State Representation 112; b) the specific interpreting and extending of the object model carried out by the NoServer module to result in optimized methods for representing and manipulating such an object model as a datagraph; c) a CRUD Engine 414 which may include encryption, validation, the processing and handling of events, the interpretation and application of permissions to objects and members and the parsing and execution of queries and updates, all impacting such an object model; and d) the execution of custom business logic by the Script Execution Engine as triggered by the data received from the client. When each of these processes is applied to the application's object model in this exemplary embodiment of the system, following the priorities and rules of such a system, the result is an optimized set of data structures represented in such a form that the NoServer module may then persist them via a datastore abstraction API 416. The datastore abstraction API 416 may direct the data to one or more supported databases or data storage mechanisms. In the exemplary implementation of NoServer, such data are structured and optimized for a NoSQL datastore; however a skilled practitioner of the art will understand that such data can be optimized for other data storage software, for example, for SQL databases (such as, for example, the open-source database MySQL) or for graph databases (such as, for example, the commercial product Neo4J). Further, because the NoServer implementation of the system employs a convention where every REFERENCE and GRABBAG member is assigned a unique URI, the datagraph for an application can be expanded beyond the data in that application's datastore. By referring to any URI, anywhere, a developer may expand the datagraph to include, for example, other data-stores as part of an application's datagraph employing all of the methods that the invention provides on those other data-stores.

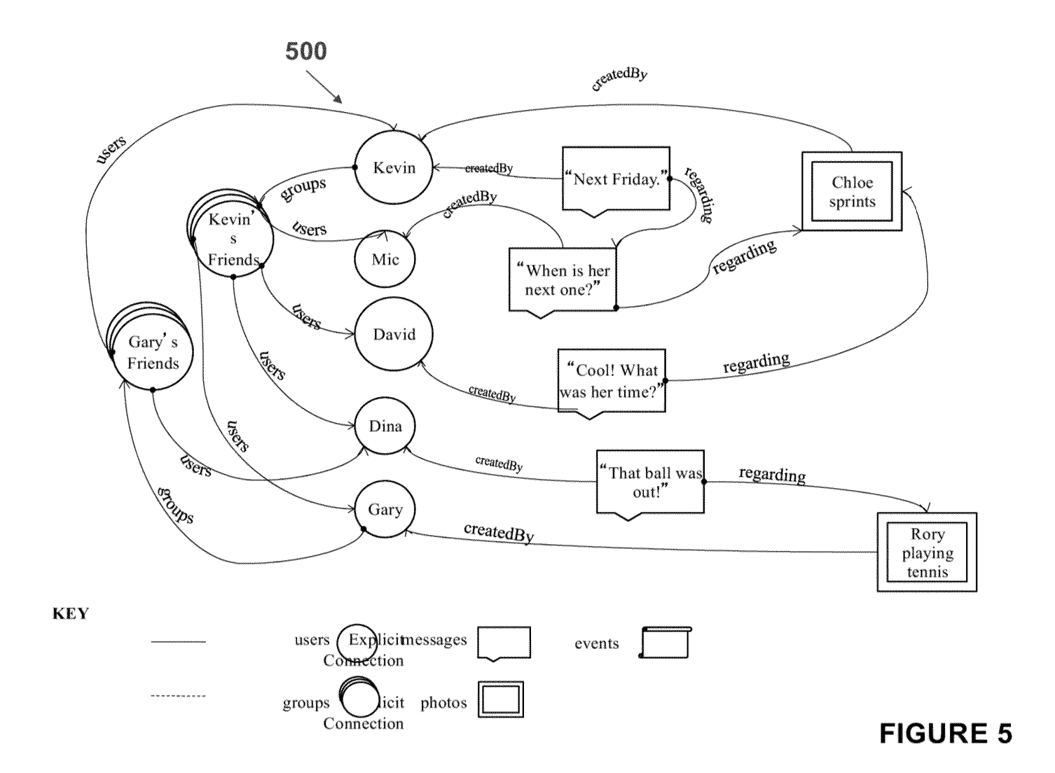

FIG. 5 illustrates an example of a data model 500, called “Amongst Friends,” that is a set of information, categories of objects and their relationships to each other, which a developer might wish to represent in application code using a client-side programming language. The number of types of object, the number of relationships between them, the number and types of data of the members of objects, the permissions provided to individual users and groups and associated with collections, objects and members of objects and then nesting of all of these, can result in extremely large and complex data models. The depicted data model in FIG. 5 is a simple way to describe the system in the context of an exemplary implementation and the example may be extrapolated to a data model of arbitrary complexity. As shown in FIG. 5, a developer might describe a group (illustrated as circles in FIG. 5) called “users,” that will be registered in the client-side application created by such a developer. In the example, there are five users, Kevin, Mic, David, Dina and Gary. A developer may want to have such users be able to create and also belong to groups (shown as overlapping circles in FIG. 5); in the example, users can have and be a part of groups of friends and specifically, the user Gary has a group of friends consisting of users Dina and Kevin, while Kevin has a group of friends consisting of Mic, David, Dina and Gary. In addition, a developer might create other objects such as events, messages (shown as a comment box in FIG. 5) and photos (shown as double rectangles in FIG. 5.) In the example, users can create messages. Those messages are created as text and the messages themselves can be regarding (that is, can reference) any individual object, of any kind that exists in the data model, either another message, a user or a photo. Finally, the photo object can be created (e.g. taken and uploaded by a mobile phone or uploaded using a desktop file system) by a user as an image file (normally represented in a programming language as a byte array, sometimes referred to as a Binary Large OBject of BLOB). Typically when developers design data models, the relationships between objects are described in one direction: for example, in the data model, it's clear the developer wants to be able to tie a user to a photo through an createdBy relationship. But it is not clear whether the developer will ever need to query, when looking at a photo object, “who created it,” in which case a developer would need to represent that link as “bi-directional.” In most cases, the data model designed at the beginning of the application development process will change as the developer realizes that other “relationships” are salient to the application.

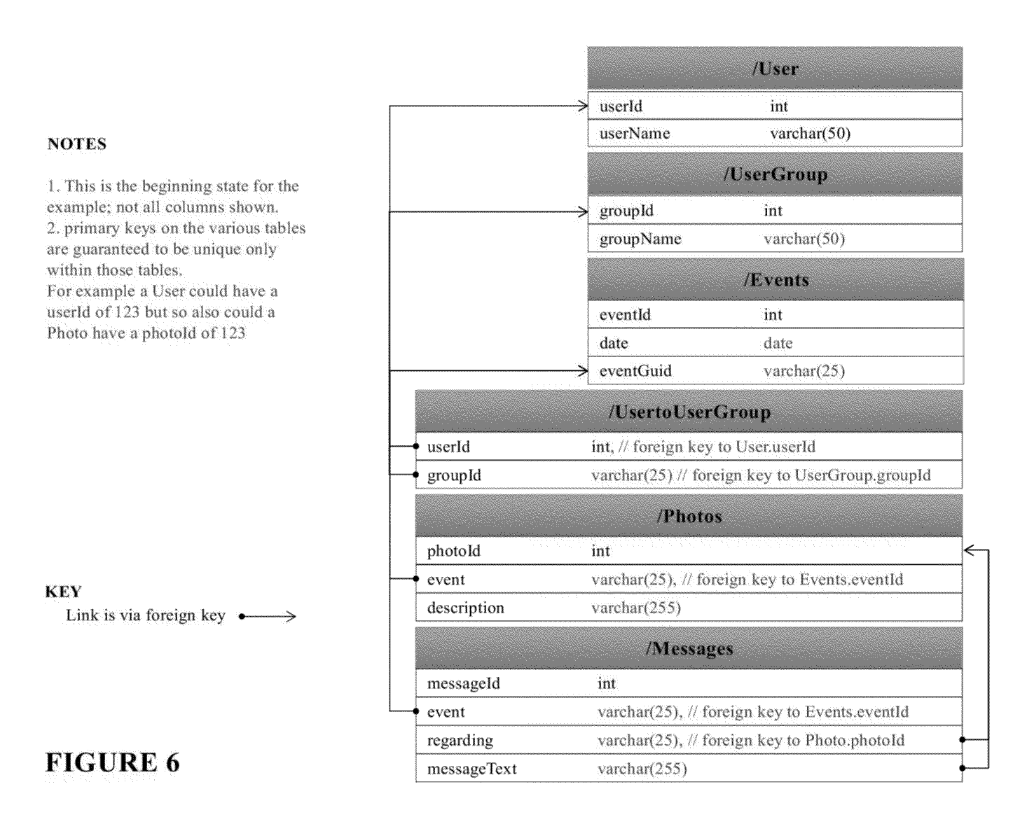

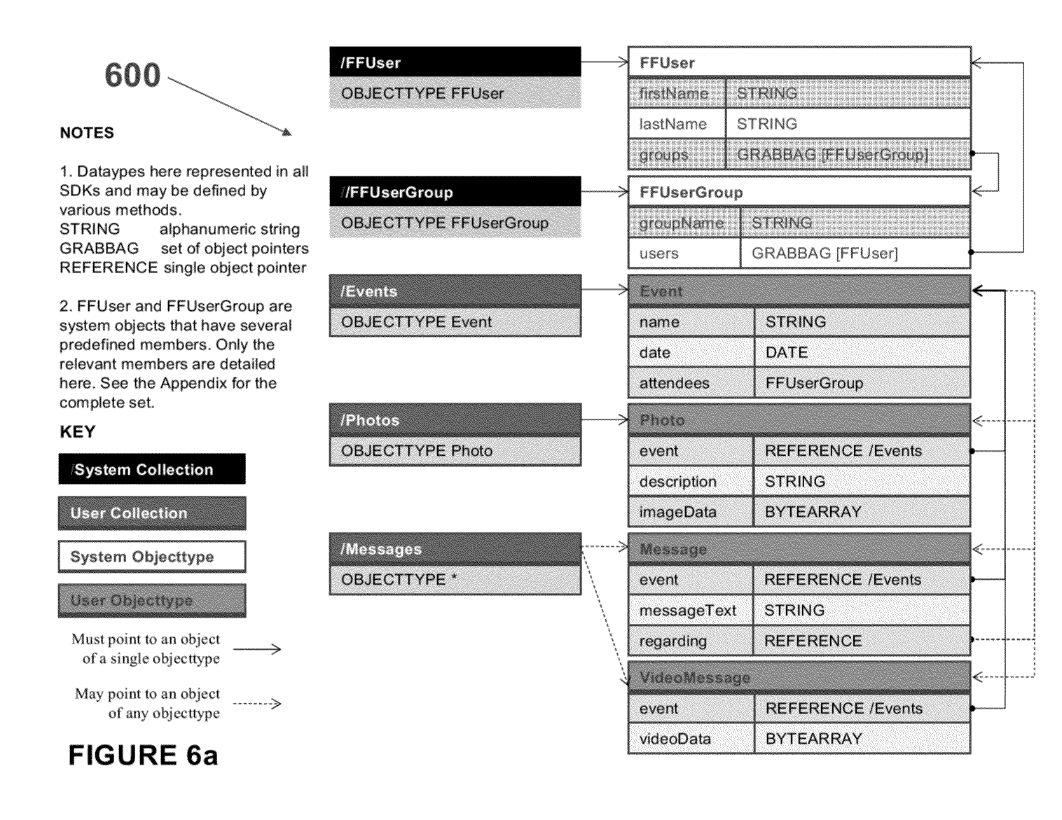

FIG. 6 illustrates an RDBMS approach to creating an object model from the data model represented in FIG. 5. The RDBMS approach is used to contrast the approach which may be used in an exemplary embodiment.

One Object, Referencing Another Object, of a Specified Object-Type

Assuming a developer may be using an RDBMS, it is straightforward to build an object model which may traverse the data model. In this case, get all of the Messages objects created by a particular user, ‘Mic’, and all of the Photos objects about which those Messages are regarding (note that multiple rows may be returned if a Photos object has multiple Messages objects associated with it):

select m.*, p.* from Messages root, Photos p where root.createdBy =
‘mic’ and
root.regarding = p.photoGuid

One Object, Referencing Two Objects, of Two Different Object-Types

The data model, however, also requires that the application, in addition to a “regarding” relationship to a Photo object, have a “regarding” relationship to another Message object. In this case, the Messages table might be amended as follows:

Messages (primary key == messageGuid)

| messageGuid varchar(25), | |
|---|---|
| createdBy | varchar(25), // foreign key to User.userGuid |
| rePhotoGuid varchar(25), // foreign key to Photo.photoGuid | |
| reMessageGuid | varchar(25), // foreign key to Message.messageGuid |

messageText varchar(255)

With that change, a Messages object now has links to either Photos objects or Messages objects. The following query might return all of the Messages which a particular user, ‘Mic’, has created and all of the data, whether from Photos or Messages objects, which those Messages objects were regarding. (Note: the following example uses the MS SQL syntax, for convenience, with *=representing a left outer join)

select m.*, p.* from Messages root, Photos p, Messages m where
root.createdBy
= ‘mic’ and root.rePhotoGuid *= p.photoGuid and root.reMessageGuid
*=
m.messageGuid

One Object, Referencing Any Object, of Any Number of Different Object-Types

In the future, a developer may wish to have Messages objects “regarding” an object of ANY other object-type (such as Movies, Restaurants and Videos). Every time a new object-type is added, which a Messages object can be “regarding,” the developer will need to 1) alter the Messages table by adding the new foreign key; and 2) modify this query.

It will be apparent to a practitioner of the art that joining across many other tables using left outer joins will lead to a) slower performance as the number of related objects grows; and b) unwieldy result sets containing all of the columns from all of the tables. A solution to this problem might be to implement the same query in two stages:

1. get result set cursor for “Select * from Messages where createdBy =
‘mic’”
2. iterate through the result set
if <this rePhotoGuid> is not null
select * from Photos where photoGuid = <this rePhotoGuid>
else if <this reMessageGuid> is not null
select * from Messages where messageGuid = <this reMessageGuid>

One Object, Referencing Any Number of Sets of Objects, of Any Number of Different Object-Types

Finally, the requirements might be extended such that a Messages object be “regarding” a set of objects of any number of different object-types, rather than “regarding” an object of just a single object-type, for instance, where a Messages object can be “regarding” five (5) Photos objects, or three (3) Photos objects and ten (10) Messages objects, or one (1) Movies object, five (5) Users objects and three (3) Restaurants objects. In this more complex case, it will be clear that a significant re-architecture of the application's object model will be required, a re-architecture which will certainly be time-consuming and costly. One common solution might be to an implement an additional join table for every potential relationship: for every new relationship added, the architecture must be changed and additional definitions added. As a small sample of such possible changes:

MessageToPhotos (primary key == composite key of
messageGuid + photoGuid)

| | |
|---|---|
| messageGuid | varchar(25), |
| photoGuid | varchar(25)MessageToMessages |

MessageToUsers (primary key == composite key of
messageGuid + userGuid)
MessageTo Videos (primary key == composite key of
messageGuid + videoGuid)
MessageToRestaurants (primary key == composite key of
messageGuid +

restaurantGuid)

MessageToMovies (primary key == composite key of messageGuid +
movieGuid)

(and so on) In contrast to the common approach in FIG. 6, FIG. 6a diagrams an object model 600, derived from the same data model in FIG. 5 which can be created and coded by a developer in an exemplary embodiment of the system. A practitioner of the art will recognize right away that the model includes separate definitions for collections and objecttypes which is unique to the exemplary embodiment and very powerful.

Objecttypes

There are Six objecttypes are shown in the example, two system objecttypes, FFUser and FFUserGroup which can be leveraged by the developer to create users and groups, an Event objecttype, a Photo objecttype, Message objecttype. There is an additional objecttype, VideoMessage that is not possible or present in the common approach to illustrate the separation of collections from objecttypes.

Collections

Five collections are described in the example, two system collections, an FFUser collection that is “typed” to contain only FFUser objecttypes and FFUserGroup that is “typed” to contain only FFUser Group objecttypes, an /Events collection that is “typed” to contain only Event objecttypes, a /Photos collection, which is “typed” to contain only Photo objecttypes and a /Messages collection which is not “typed” and can contain any objecttype. Again, this is not possible with the common approach and is unique to the exemplary embodiment (see Appendix A for a complete specification of FFUser and FFUserGroup as well as a specification of the syntax of URIs on an exemplary embodiment).

Object Metadata

Essential to the system are a number of system generated data parameters that are created for every object. These include “createdBy”—the guid of the user that created the object, “updatedBy”—the guid of the user that last updated the object, “createdAt”—the date/time the object was created and “updatedAt”—the date/time that the object was last updated and “clazz”, the name of the object class for the object which is used to deserialize the object in the client SDK. In addition to being essential for many of the operations performed by the system, they also simplify data modeling for the developer.

References

Complex object structures can be easily stored by value. For example the following is allowed and will store and return a complex object structure.

CREATE OBJECTTYPE Message (Event EVENT, MessageText STRING, Regarding OBJECT)

However, it is almost always desirable to store contained objects in their own collections so that they can be managed on their own and changes reflected automatically for any object referencing them. Unique to the system is that an object's REFERENCE member may either a) point to one, enumerated object-type or b) point to any object-type. In the example, objecttype definition for Message includes two references as follows:

CREATE OBJECTTYPE Message (Event REFERENCE /Events, MessageText STRING, Regarding REFERENCE)

The “event” reference is defined to require an object in the “Events” collection, and by implication, must be an objecttype “Event”. The second reference, “regarding” does not specify a collection and as a result can be any objecttype stored in any collection. It is important to note that the “clazz” metadata preserves the integrity of the objecttype end-to-end and can also be used to query the collection for specific objecttypes.

Grab Bags

To refer to many objects by reference, the object model implementation a developer might employ on the system 600 leverages a unique backend data-type, GRABBAG, as shown in the FFUser and FFUserGroup objects. A grab bag is a set of object pointers. A grab bag member may have none or one or more pointers and a grab bag's pointers may be limited to a) pointer solely to objects from a single collection; or b) pointer to objects from any collections. Unlike the REFERENCE data, the GRABBAG data is not as part of the object data. Instead, the system keeps all grab bag data in a separate, system-managed collection on the application's backend. For example, in the data model illustrated in FIG. 5 and modeled in FIG. 6a, FFUser object with the guid ‘guy’ has a member ‘group’ of backend data-type GRABBAG with a groupName ‘friends’ restricted to point to FFUser objects.

The FFUser object with guid ‘guy’ on the backend, after the objects are persisted with data contains only the following information:

{clazz:‘FFUser’, guid:‘gary’, firstName:‘Gary’, lastName: ‘Casey’}

The FFUserGroup object for FFUser with guid ‘guy’ on the backend, after these objects are persisted with data, contains only the following information:

{clazz:‘FFUserGroup’, guid:‘garys_friends’, groupName:‘friends’}

Instead, the /_grab_bags collection maintained by the system contains keys that are complete URIs. Because they are complete URIs, each key explicitly contains all the information it needs to make clear the relationship between the two objects. In the following, without any information explicitly contained in the FFUser object or the FFUserGroup object, the system knows that “an FFUserGroup with guid ‘garys_friends has a grab bag called ‘users’ which points to two FFUser objects, ‘diva’ and levin'.”

{key:‘/FFUserGroup/garys_friends/users/FFUser/dina’}
{key:‘/FFUserGroup/garys_friends/users/FFUser/kevin’}

If another grab bag called ‘bffs’ were created for the FFUserGroup with guid ‘garys_friends’ the FFUserGroup object model would not change; however, the relevant keys would be added to the /_grab_bags collection:

{key:‘/FFUserGroup/garys_friends/users/FFUser/dina’}
{key:‘/FFUserGroup/garys_friends/users/FFUser/kevin’}
{key:‘/FFUserGroup/garys_friends/bffs/FFUser/anne’}
{key:‘/FFUserGroup/garys_friends/bff s/FFUser/dave’}

The GRABBAG data-type serves the following purposes: 1) object models are kept as simple and pure as possible, which decreases complexity of the modeling process and reduces the time required by the developer to maintain and alter object models over time; 2) the relationship of the objects pointed to by the grab bag are maintained by the system and the relationship information is always retrievable based on a fully-described key; and 3) since grab bags can be treated by the developer as parts of the object model, without being tied directly to them, grab bags provide traversable relationships that are dynamically updated during the life of an application without requiring re-configuration or changes to the objects themselves.

Grab bags are not limited to system objects such as those in FFUser or FFUserGroup. Any object may contain member(s) of backend data-type GRABBAG. To extend the example illustrated in FIG. 6a, one might create a grab bag called ‘favorites’ which could contain pointers to a user's favorite messages and favorite photos.

/FFUser
firstName STRING
lastName STRING
groups GRABBAG [/FFUserGroup]
favorites GRABBAG

As with each grab bags, the favorites grab bag will be maintained separately by the system from the FFUser object in the same ways described above. In the case of the ‘favorites’ grab bag, referenced objects are not constrained to a particular collection, in contrast to the ‘groups’ grab bag which may only contain pointers to objects in the /FFUserGroup collection. It should be noted that the ability to have an object member which is a set that can contain any object-type from any collection is a unique feature of the system.

Back References

The system and method automatically creates and manages a special grab bag for every object, without intervention by the developer. For every object persisted to an application's backend, the system creates an entry to a system grab bag called BackReferences which automatically tracks which other objects refer to it through either a REFERENCE member or a GRABBAG member.

Looking again to the “Amongst Friends” example's data model illustrated in FIG. 5 and its corresponding object model illustrated in FIG. 6a, a back reference is created for every object referenced in an FFUser object's ‘groups’ GRABBAG, for every object referenced in an FFUserGroup object's ‘users’ GRABBAG, for the object referenced in a Message object's ‘event’ REFERENCE, for the object referenced in a Photo object's ‘event’ REFERENCE and for the object referenced in a Photo object's ‘regarding’ REFERENCE.

Back references allow the developer, given any persisted object, to answer the question: which other objects reference me? In the “Amongst Friends” example, if one asked which objects point to the Photo object called ‘Chloe sprints’, there would be two of them, both Message objects where the regarding member of type REFERENCE points to the ‘Chloe sprints’ Photo object. Specifically, those are the Message objects ‘When is her next one?’ and ‘Cool! What was her time?’. Further details on back references are provided in the Queries section below.

Imputed Datagraph

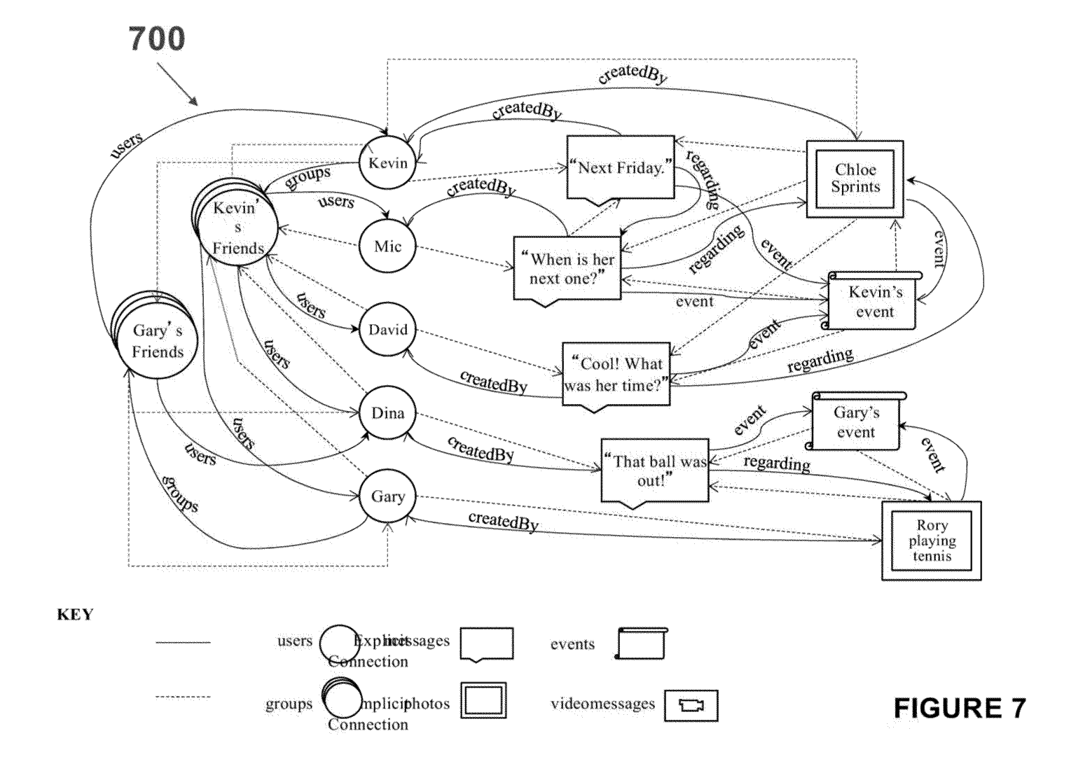

By leveraging grab bags, references and back references (itself a system-generated grab bag), the developer's simple object model may be traversed and queried as a datagraph, in ways the developer may not have initially modeled. To illustrate, FIG. 7 represents a datagraph 700 derived from the object model originally depicted in FIG. 5. In addition to traversing forward along the members' REFERENCE and GRABBAG pointers, the developer can traverse the back references, represented by the dotted lines in the diagram, each of which is an implicit connection provided by the system-generated back references. The system and method reduces the geometrically expanding complexities of expressing relationships of such highly-linked data models to the least possible effort, making such code easier to maintain and generating fewer dependencies and errors.

It is useful to contrast the changes to the object model required by an exemplary embodiment illustrated in FIG. 6a and the “common approach” illustrated in FIG. 6 and previously described, both derived from the same data model illustrated in FIG. 5:

One Object, Referencing Two Objects, of Two Different Object-Types

Unlike the “common approach”, a single change would be required to the object model described in FIG. 6a, adding a member called ‘regarding’ of backend data-type REFERENCE to the Messages object-type as follows:

CREATE OBJECTTYPE Messages (event REFERENCE /Events, messageText STRING, regarding REFERENCE)

By adding the ‘regarding’ member as a REFERENCE which is not defined as “from a single collection,” a Message object can now have a “regarding” relationship to an object from the /Photos collection, the /Messages collection, the /Events collection and so on. A practitioner of the art will recognize right away that such flexibility in a reference, that is to any collection and object type, is unusual and quite useful.

One Object, Referencing Any Object, of Any Number of Different Object-Types

Unlike in the “common approach”, in an exemplary embodiment, no additional change is required to the object model above, since ‘regarding’ can reference any number of different object-types, not just two.

One Object, Referencing Any Number of Sets of Objects, of Any Number of Different Object-Types

Unlike in the “common approach”, in an embodiment, a developer does not have to significantly re-architect the object model. The only change required is to use a GRABBAG backend data-type for the ‘regarding’ member, rather than a REFERENCE data-type.
CREATE OBJECTTYPE Messages (event REFERENCE /Events, messageText STRING, regarding GRABBAG)

A person skilled in the art will appreciate that a GRABBAG data-type, which is not defined as “from a single collection,” can point to any number of objects, from any collection and of any object-types and is thus sufficient both for: a) any number of objects that a Message object wishes to point to via the ‘regarding’ and b) any number of different object-types of those objects that a Message object wishes to point to via the ‘regarding’ grab bag. Thus, new object-types representing a new kind of relationship require no additional change to the object definition. Finally, it should be noted that, in all of these cases, system-provided back references ensure that the datagraph can be traversed in the “backwards” direction as well, as described in more detail below in the Queries and Traversals section.

As the examples show, the system and method specifically eliminates a vexing problem found in relational database management systems: the need for the developer to perform “outer joins,” forming new tables in order to create new relationships between objects. While such joins are easily done on relatively simple models, on a large scale, such joins significantly degrade performance and scalability. In some instances, for example, where a large number of relationships must be represented in the model and queried, the developer's task becomes even more difficult; specifically, the developer will need to manage, maintain, traverse and keep track of a geometrically expanding number of “relationship tables” in his code. If a “message” or a “like” can be “regarding” anything and there are 20 tables (e.g. “users, groups, photos, messages, videos, events, albums and so on), for instance, an RDBMS simple cannot reasonably run an outer join: a developer would need to get a cursor, iterate through the results of the first query (get me all my “messages”), inspect each row and query the related table all of which represents a huge amount of effort for the developer. The system and method handles all of that complexity with little performance impact. A practitioner in the art will also be aware that NoSQL data-stores have proliferated to support applications developed on web- and cloud-based platforms, primarily aimed at providing scalability and performance with a simple key/value storage system. While NoSQL data-stores do provide such scalability and performance improvements, by most accounts, developers do not have access to the ready-made functionality such as that available in an RDBMS context (e.g. SQL) which allows for relationships encapsulated in “join tables” across objects to be programmatically formed, traversed and queried: for all of their complexity problems and inefficiencies, “joins” are useful to an application developer. The system and method gives application developers using NoSQL a simple, efficient way to 1) represent a data model as object models; 2) to establish relationships between those object models; and 3) to traverse and query those models, without a) relying on additional, client-side tables or objects to map the relationships between the original object models; and b) adding members to each of the original object models, for relationships between them that the developer wishes to establish. In effect, the system and method takes these common concerns for the developer and abstracts them away from the developer's concern, to the backend, where they can be managed by the system in a transparent and optimized way: the developer still has all the functionality he needs, while not needing to set up, maintain or even be aware of any of that complexity.

To illustrate how the system and method solves this problem in the “Amongst Friends” example, FIG. 6a shows that both the Photo objects and the Message objects reference the Event object with a member called event of data-type REFERENCE which must be a pointer to an Event object or NULL. It is clear, since a reference exists in the object model, that a query can be constructed which requests, “return the Event object which is referenced by the ‘event’ member of a particular Photo object.” There is not, however, any Event object member explicitly defined here, which similarly points to the Photo object that can be queried to “return the Photo objects which are referenced by a particular Event object”. However, those queries can be still be made by a developer, in an embodiment, by traversing the Event's back references, which the system automatically provides access to, in queries and traversals. Because a developer does not have to explicitly represent those relationships, the Event model remains simple, pure and efficient from an application developer's point of view. Neither does there need to be a third collection (i.e. “join table”) that a developer must create and manage, enumerating the relationship between /Events and /Photos, again reducing the number and complexity of objects that a developer must directly create and manage. In this way, the datagraph may be traversed forward (from /Photos to /Events, where there is an explicit reference to the ‘event’ member) and backward (from /Events to /Photos, where there is not an explicit reference) in a scalable, high performance manner.

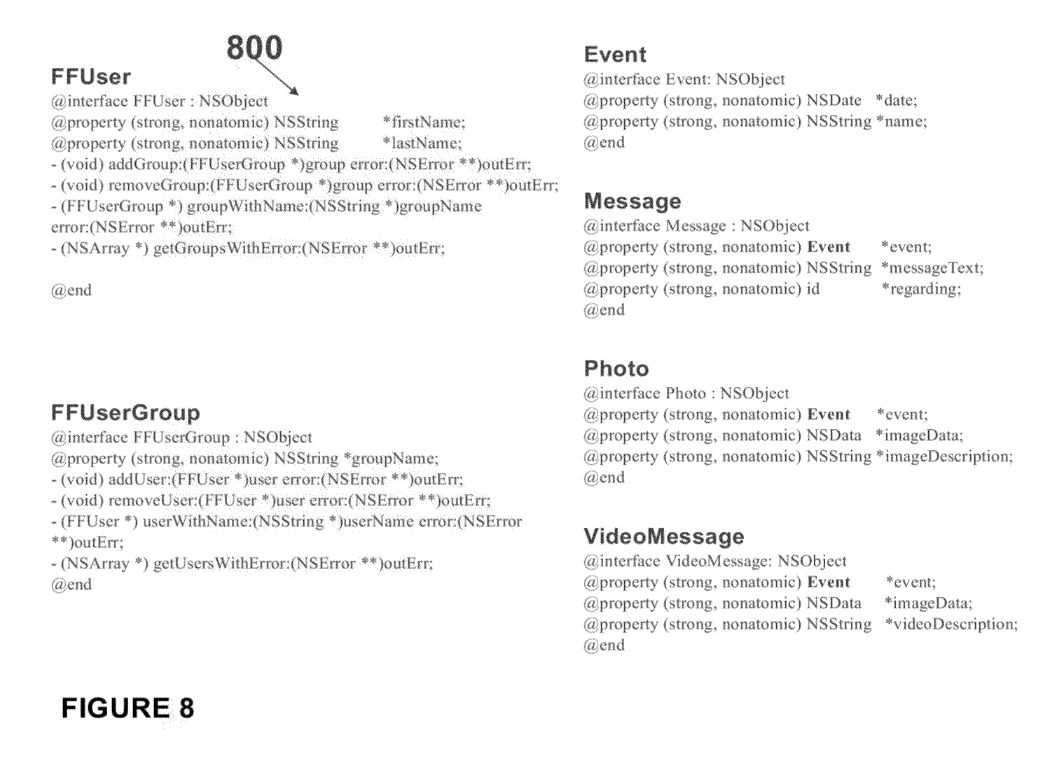

FIG. 8 illustrates a set 800 of Objective-C interfaces, which would be created by a developer, in an exemplary embodiment, for the “Amongst Friends” example. A practitioner of the art will recognize that the object model leverages the native data-types and methods available in Objective-C without any proprietary protocols or subclasses and that a similar approach could apply to any programming language. For those objects and data-types that are specific to the system and method and not native to the programming language, the system and method provides an SDK with its associated libraries and methods. For example, a developer can add groups to users and add users to groups. A complete set of API documentation is provided in the Appendices A1-A4, describing all such libraries and methods for an exemplary embodiment. As was described earlier, if a developer deploys such application client code, the system and method may automatically generate an application's backend and instantiate the object models to that backend, first serializing those models from the client-side and then deserializing them on the server-side and then processing them (such as in the NoServer embodiment illustrated in FIG. 4), if the system is configured to the learn mode. Alternatively, a developer may specify those same object models in the configuration file, application.ffdl file, using FFDL. A developer also may use a combination of client code deployed in learn mode together with object models defined in FFDL, in that configuration file. In all cases, the backend state representation of the object models, described in FFDL, is always available to a developer. The current backend state representation is the definitive state of the application's object models at a given time, specifically, the current definition of all collections and object-types created for an application which have been persisted to the application's backend.

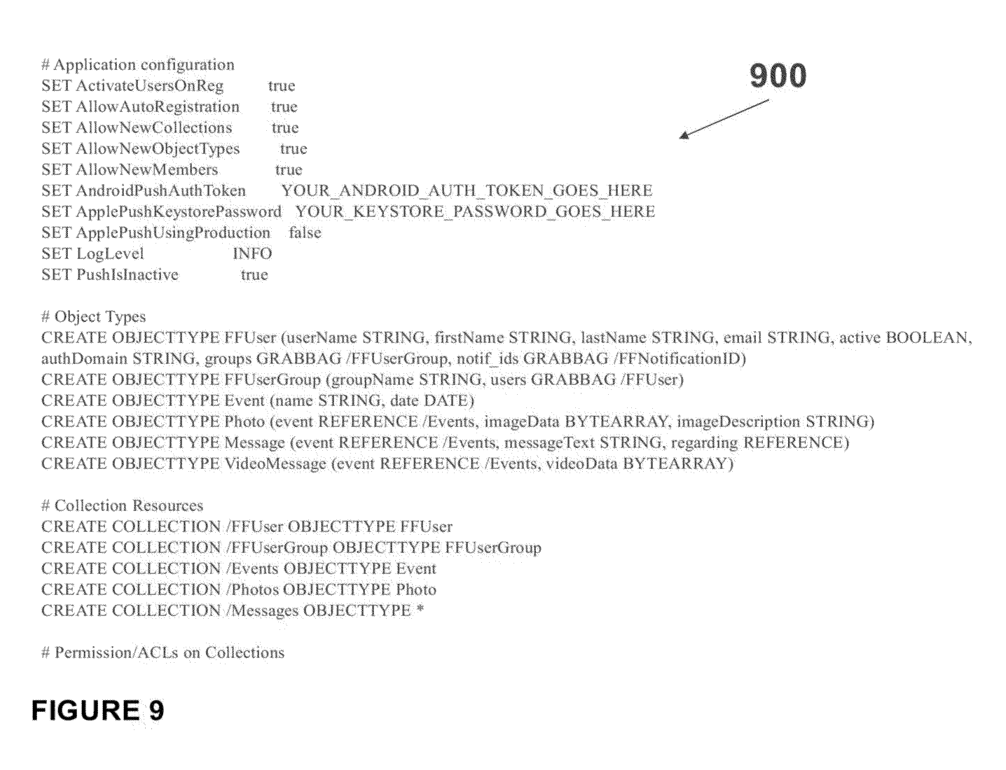

FIG. 9 illustrates an excerpt from a backend state representation 900 for the “Amongst Friends” example. The application configuration settings allow a developer to set defaults that determine the functionality of an embodiment of the system and method, including the learn mode settings (AllowNewCollections, AllowNewObjectTypes and AllowNewMembers) that set the system to automatically infer the object models on the backend from what the developer explicitly creates and persists from client-side code. In the backend state representation, the object-types are specified for FFUser, FFUserGroup, Event, Photo and Message and collections are created, /FFUser, /FFUserGroup, /Events, /Photos and /Messages. The backend state representation acts as a bridge between the client-side code and the backend, in the sense that it indicates the “true state” of those items on the backend and a complete set of FFDL commands and settings as well as their syntax is available in the Appendix A.

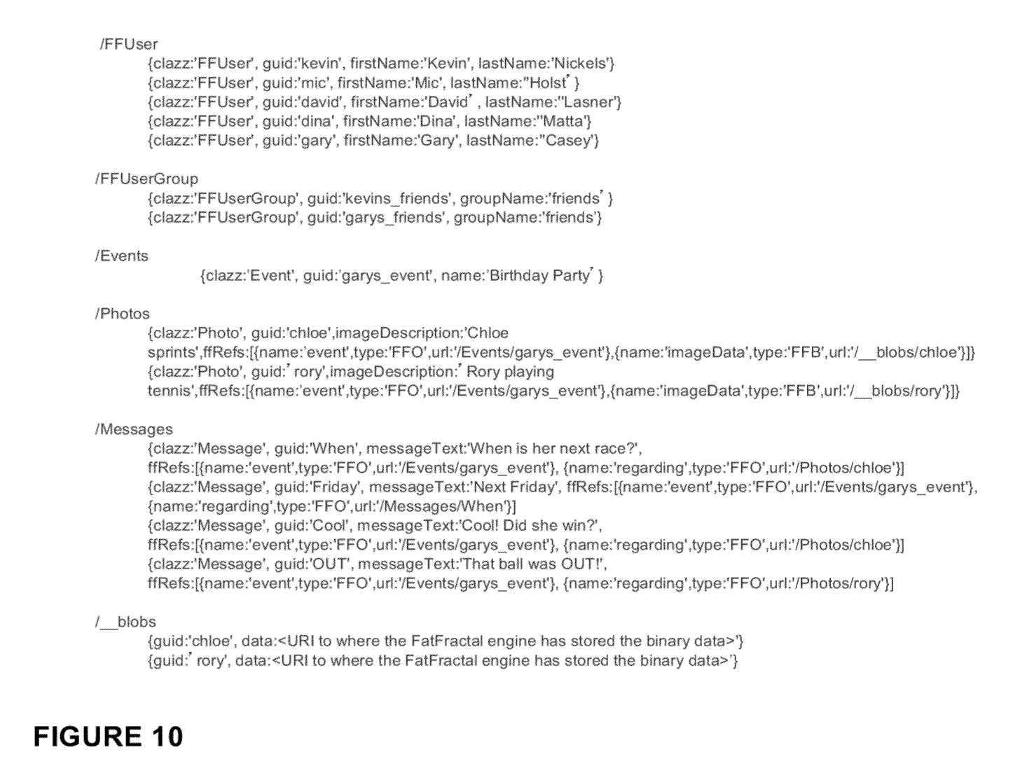

To summarize the journey through the “Amongst Friends” example so far, which details application development system and method for object models of a web- or cloud-based applications development platform, the original data model diagrammed in FIG. 5 is turned into an object model in an exemplary embodiment of the system and method in FIG. 6a which, given grab bags and back references, generates a datagraph shown in FIG. 7. The headers in a representative programming language Objective-C, from an exemplary embodiment, are shown in FIG. 8 and FIG. 9 shows an excerpted set of the representation of the object models described in FFDL from the actual backend state representation after those object models are persisted to the application's backend. An excerpted set of the backend object architecture of those same object models is shown in FIG. 10-12. The backend object architecture includes the specific data structures and internal representations and formats which are maintained by the NoServer module, an exemplary implementation of the system and method. As shown in FIG. 10, the five collections from the “Amongst Friends” example, /FFUser, /FFUserGroup, /Events, /Photos and /Messages are all maintained on the backend object architecture in a form to facilitate speed of retrieval and other data operations as well as queries. /FFUser in addition to storing class (called ‘clazz’ to avoid conflict with a reserved name), guid, firstName and lastName also stores other system data (a complete FFUser specification is attached in the Appendix). The /FFUserGroup collection stores class, guid and groupName; however the relationships between /FFUser and /FFUserGroup, which are represented in the object model by grab bags, are not stored in these objects, but remain independent of them. REFERENCE backend data-types are included in the backend object architecture as ffRefs entries: in /Photos, an ‘event’ reference refers to a specific, named object in the /FFUser collection and the imageData reference refers to a separate data structure maintained by an embodiment called /_blobs. The /_blobs collection keeps track of a URI for each BLOB element, such as a picture, video, document or any other byte array member, so that the system and method can systematically store such BLOBs independently. An embodiment of the system and method may store all BLOBs to high speed data storage which may be appropriate for very large files. In this embodiment, the backend object architecture described here is optimized by the NoServer module for a NoSQL database, structured simply in key-value pairs; a practitioner of the art will observe that, although the functionality would remain consistent, the specific form of both the data structures and their internal representations and formats might vary if optimized for other underlying data storage environments, such as an RDBMS or a Graph Database.

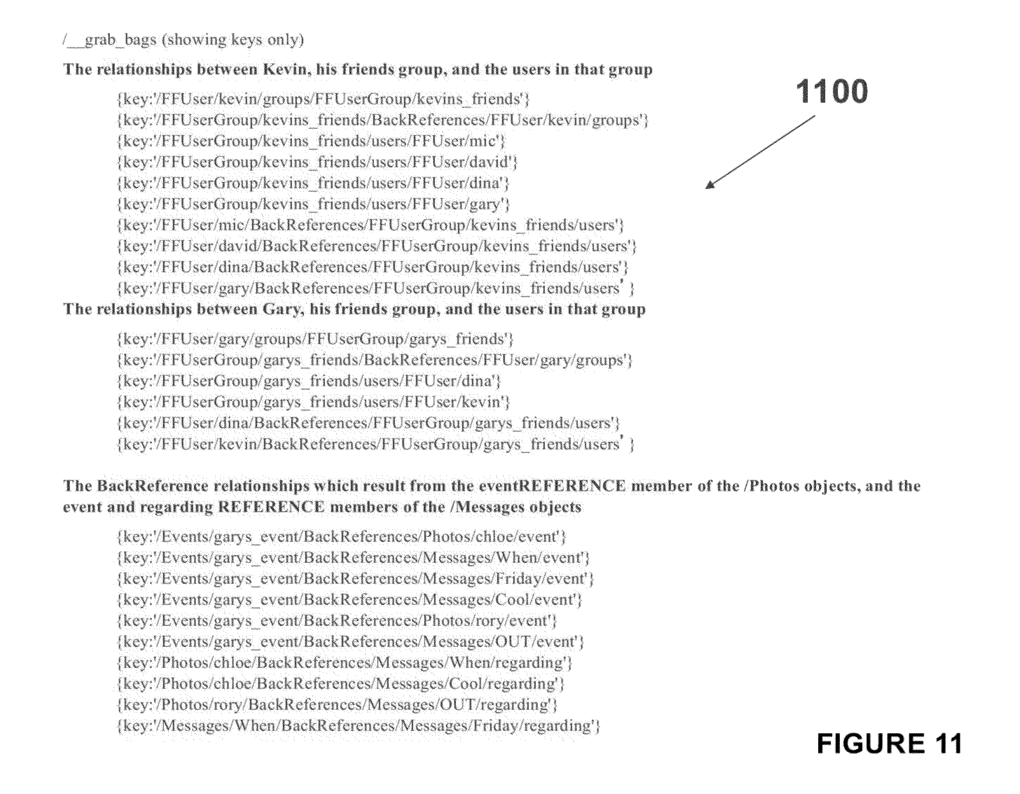

FIG. 11 enumerates a collection 1100 called /_grab_bags. This system-maintained list contains all indirect references which were created by an application developer through either 1) a client-side programming language; 2) a server-side programming language; or 3) in an application.ffdl configuration file. Back references are a system-generated grab bag that the system and method automatically creates and maintains for every member of type GRABBAG or REFERENCE backend data-type, each of which can only point to one or more objects (or NULL). For performance purposes, a key field for each entry will be the fully-formed URI to the referenced object.

For example, the following is the /_grab_bags entry linking the grab bag ‘groups’ (a member of /FFUser object with guid ‘guy’) to a group in the /FFUserGroup collection called ‘garys_friends’ for the exemplary data model in FIG. 5:

{key:‘/FFUser/gary/groups/FFUserGroup/garys_friends’}

And the following two entries link the grab bag ‘users’ (a member of an FFUserGroup object with guid ‘garys_friends’) to two FFUser objects, one with guid ‘diva’ and one with guid ‘kevin’.

{key:‘/FFUserGroup/garys_friends/users/FFUser/dina’}
{key:‘/FFUserGroup/garys_friends/users/FFUser/kevin’}

The above entries, when persisted to the application's backend, automatically generate back references contained in the backend object architecture as part of the /_grab_bags collection. In the first of the three examples below, since there is a grab bag member such that that the FFuserGroup called ‘garys_friends’ has a member called ‘users’ pointing to an FFUser called ‘diva’; therefore, a back reference is automatically generated that shows that the /FFUser called ‘diva’ is being pointed to by the FFUserGroup called ‘garys_friends’ and in particular by its member ‘users’. Simply put, the back references “point backwards.”

{key:‘/FFUser/dina/BackReferences/FFUserGroup/garys_friends/users’}
{key:‘/FFUser/kevin/BackReferences/FFUserGroup/garys_friends/users’}
{key:‘/FFUserGroup/garys_friends/BackReferences/FFUser/gary/groups’}

For the /Events, /Photos and /Messages collections, the information for grab bags, including back references, is similarly maintained.

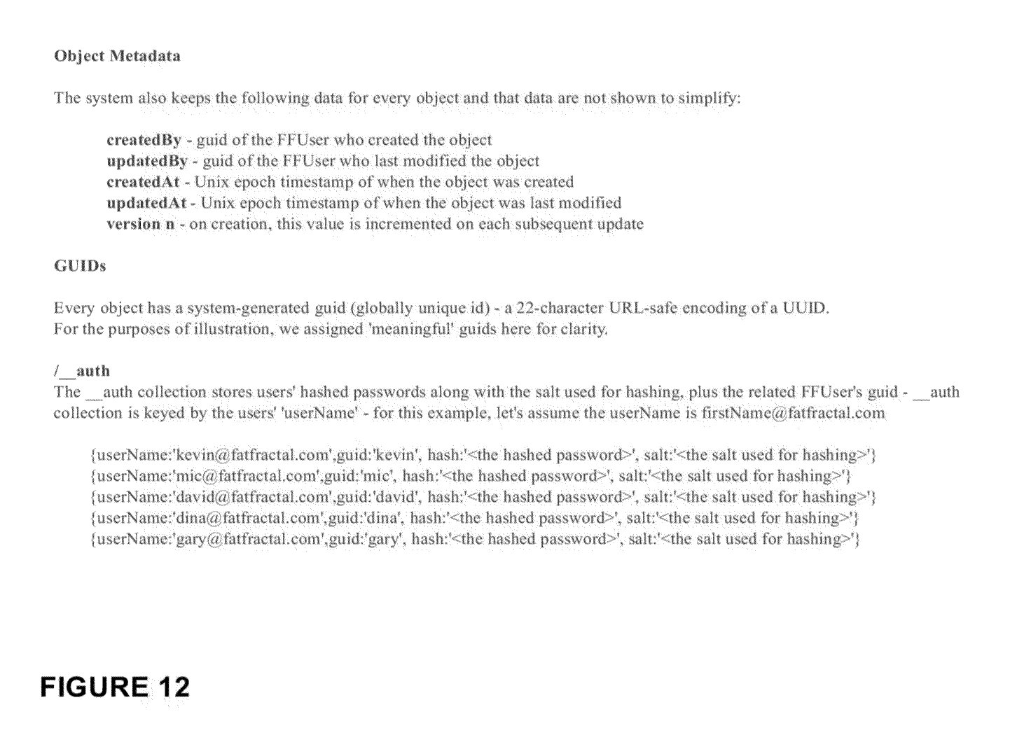

FIG. 12 illustrates other data that is maintained by an exemplary implementation to allow application developers access to other object information that may be necessary in querying or traversing the datagraph. As an example, the createdBy metadata field will contain the guid of the FFUser who created the object which allows an application developer to query or traverse an objects which were created by a particular FFUser (for a complete list of metadata, see Appendices A1-A4). Another system-maintained collection called /_auth is maintained separately for security purposes and maintains “passwords” and relevant hashing information.

ACLs and Permissions

Permissions, often in the form of Access Control Lists (ACLs), can be found in many web- and cloud-based platforms. In general, ACLs can be created that give specific groups of users read and write permissions on specific collections of objects. In the system, ACLs may be established declaratively, prior to running the application. The NoServer module example on the system platform described above integrates ACLs and their associated permissions into the datagraph that is imputed from the application developer's object models. In this way, the datagraph is dynamically customized for each user of the application based on that user's permissions and the groups that the user is or becomes a member of or alternatively, based on the groups or permissions the user is removed from at runtime. Due to the ACLs, a user only has access—can traverse and query along the datagraph—if that user has applicable READ or WRITE permissions; otherwise, that part of the datagraph is not available to that user. Essentially, then, such permissions become part of the datagraph and explicitly “gate-keep” how the datagraph may be traversed or queried by a specific user at runtime.

Declarative Permissions and Inherited Permissions

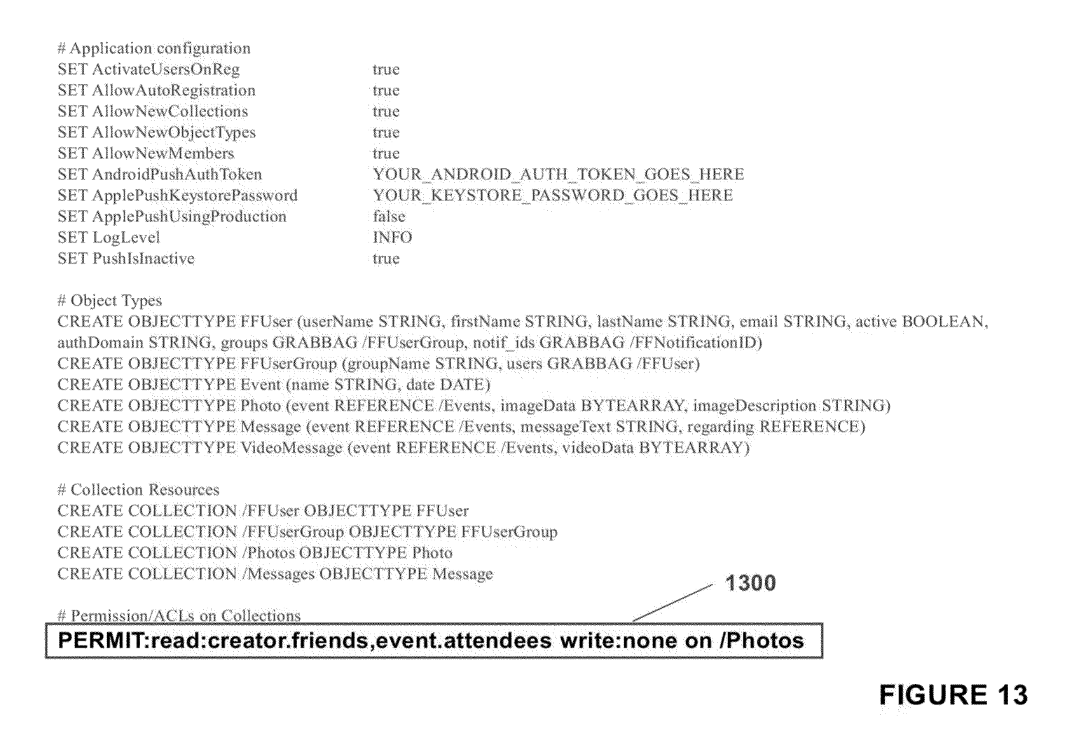

FIG. 13 illustrates a single line of FFDL 1300 which a developer might add to the application.ffdl configuration file associated with the previously-described “Amongst Friends” example (such as is shown FIG. 9):

PERMIT:read:creator.friends,eventattendees write:none on /Photos

Before adding this FFDL command, the system-wide default is that the FFUser who creates any object (the “creator”) is the only user who has permission to write to that object, meaning to change it, update it or delete it (note that in this case, “creates an object” might mean taking a picture on a mobile device or uploading a picture file of the type JPEG, PICT, RAW). By entering this PERMIT command in the application's application.ffdl file, a developer changes the default ACLs for the /Photos collection as follows: allow people in the “friends” group of the person who created the objects in the /Photos collection to have access to that person's photos. Technically, the FFDL command creates policies, one for each FFUser referenced in the creator's FFUserGroup named “friends” which permits only those FFUsers to have READ access to the objects in the /Photos collection that this creator created.

It also includes a permission setting to allow the people in the attendees group of the referred to event to have read access as well. This is done via permission inheritance. The “event” member of the Photo is a reference to an Event object in the Events collection. The Event model includes a member “attendees” that is “typed” to the FFUserGroup objecttype which contains a list of users. By specifying that event.attendees have read access to the Photo, it is able to inherit the permissions of the Event object.

Note that the permission setting of “none” means that only the FFUser, who is the creator of an object, which always has READ and WRITE access to that object can modify or delete the object. When the application starts, these defaults will be in place on the /Photos collection and consequently, the available datagraph to different users will vary.

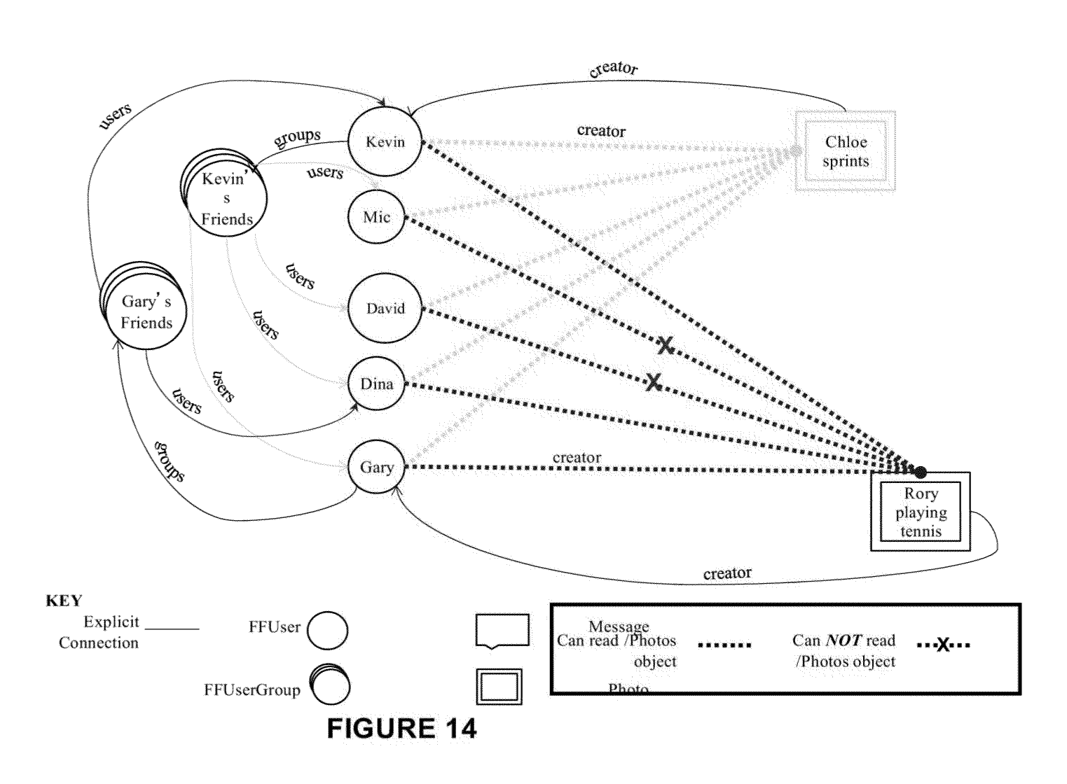

FIG. 14 diagrams how the new default ACLs change the datagraph (rather than representing every connection as in FIG. 7, only those connections relevant to the /Photos collection are shown) that was shown in FIG. 5. The first Photo object ‘Chloe Sprints’ was created by FFUser ‘kevin’. The defaults, after the PERMIT command above, allow all of the members of Kevin's FFUserGroup ‘friends’ to have READ access to ‘Chloe Sprints’. All four of the users in the diagram are members of Kevin's ‘friends’ group and therefore they all have READ permissions on that object. Kevin has READ permissions because he is the creator of that object. The second Photo object, ‘Rory playing tennis’ was created by FFUser ‘guy’. The members of Gary's ‘friends’ group are ‘diva’ and ‘kevin’. Therefore, Dina and Kevin have READ access to the second Photo while ‘nine and ‘david’ do not have READ access: essentially, their datagraphs do not include ‘Rory playing tennis.’ Gary has READ permissions because he is the creator of that object. Application developers often wish to change the permissions associated with a user or groups of users after the application is running in order to change the datagraph access for particular users or groups without changing a) the defaults set before the application runs or b) the object models they have already created. The NoServer embodiment provides such functionality to allow a developer to dynamically change ACLs and their related permissions after the application is running. Unlike other such systems, the system and method allows such READ and WRITE permission changes, by user and by group, at various levels of granularity including the collection level, the object level and the object member level to be set as differing defaults before runtime and to be changed at runtime.

Programmatic Permissions

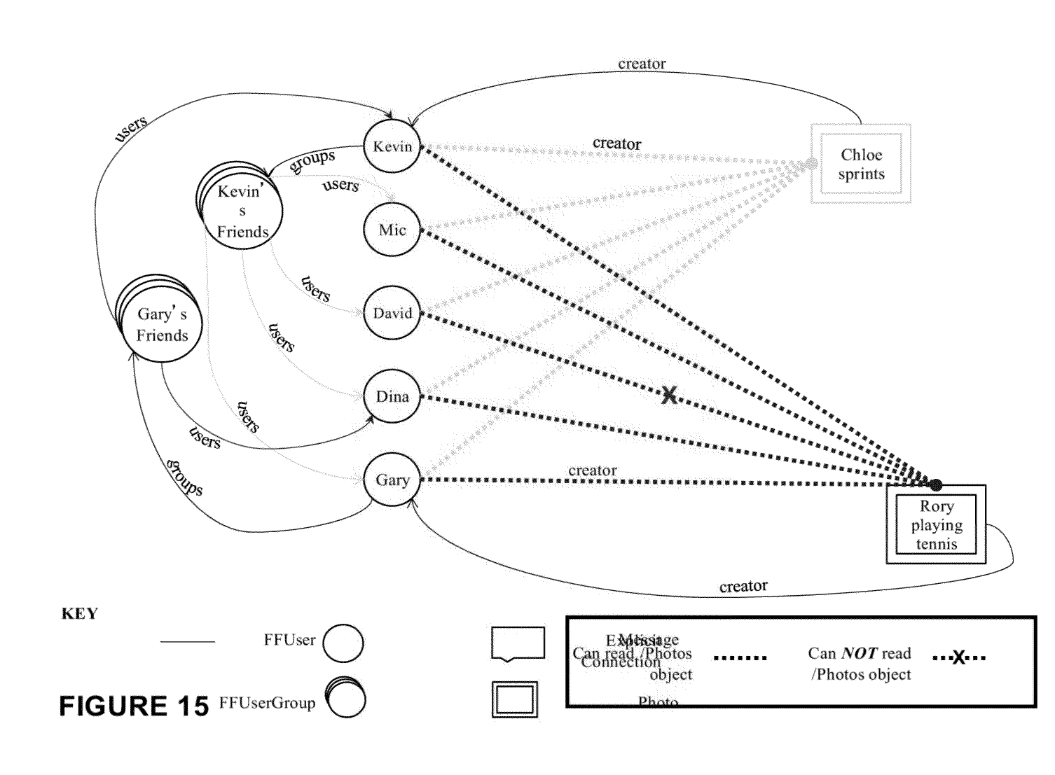

To allow Mic to have READ access to the ‘Rory playing tennis’ Photo, a simple solution would be to add the ‘nine FFUser to Gary's ‘friends’ FFUserGroup. Since all users in the ‘friends’ FFUserGroup have READ access to the Photo objects Gary created, Mic will then have such access. But, perhaps Gary only wants Mic to have access to that one photo and not to all the other Photo objects he is the creator of. In that case, a developer could write client code which will change, at runtime, the ACL for just the single Photo ‘Rory playing tennis’. Importantly, such code will not change the current permissions for any other Photo, which should remain as they are currently set. FIG. 15 illustrates such a change, allowing Mic's datagraph to include the ‘Rory playing tennis’ Photo explicitly, using the following Objective-C code from the iOS SDK (Objective-C only used as an example client programming language):

Photo *roryPhoto = [ff getObjFromUri:@“/Photo/(imageDescription
eq ‘Rory playing

tennis’)” error:&crudError];

NSMutableArray *justMic = [[NSMutableArray alloc] init];
[justMic addObject:[ff getObjFromUri:@“/FFUser/mic”
error:&crudError]];
NSMutableArray *justGarysFriends = [[NS MutableArray alloc]
init];
FFUserGroup *garysFriends = [[ff loggedInUser]
groupWithName:@“friends”

error:&crudError];

[justGarysFriends addObject:garysFriends];

[ff setPermissionOnObject:roryPhoto readUsers:justMic readGroups:justGarysFriends writeUsers:nil writeGroups:nil error:&crudError];

The setPermissionOnObject method affects only the Photo ‘roryPhoto’. It creates an ACL solely for that Photo object with READ permissions given to a) ‘Mic’ and b) the FFUsers belonging to Gary's FFUserGroup called ‘friends’ and WRITE permissions to no one, except the creator of that object. Now, Mic can READ this single Photo that Gary is the creator of, but cannot READ any other of Gary's Photo objects because Mic does not belong to Gary's FFUserGroup called ‘friends’.

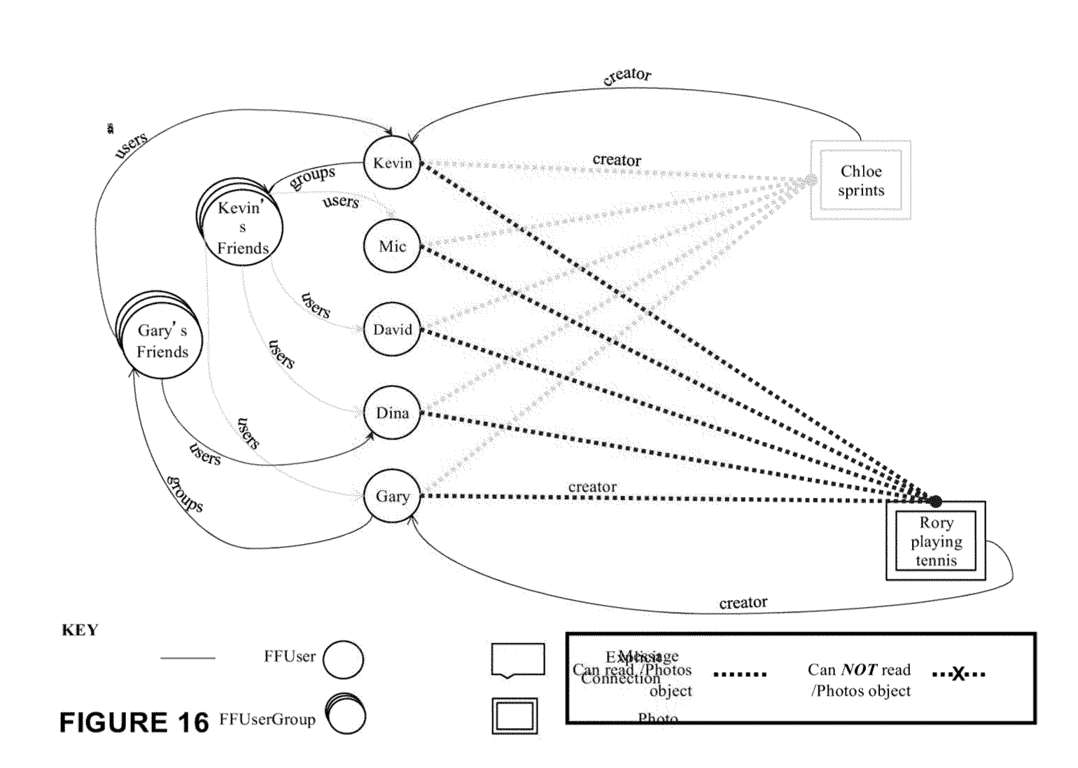

FIG. 16 illustrates the example, touched on above, where an FFUser added to Gary's FFUserGroup called ‘friends’ will have READ access to all of the Photo objects that Gary is the creator of. The Objective-C code from the iOS SDK (only as an example):

FFUser *david = [ff getObjFromUri:@“/FFUser/(userName eq
‘NSPTest_David’)”

error:&crudError];

FFUserGroup *garysFriends = [[ff loggedInUser]
groupWithName:@“friends”

error:&crudError];

[garysFriends addUser:david error:&crudError];

After this code executes, FFUser ‘david’ is part of Gary's ‘friends’ group and will have read access not only to the Photo ‘Rory playing tennis’ but any other Photo that Gary is the creator of. The WRITE permissions continue to be set as in the default established by the Permit command: no FFUser has write access to any Photo except the creator of that Photo. The system includes a variety of methods to assign permissions both as defaults in an application.ffdl file and dynamically at run time. The general syntax for the PERMIT command follows:

PERMIT read:<permission> write:<permission> ON /<collection>
where <permission> is one of the following:
none
public
creator.<group belonging to object creator>
system.<group belonging to system user>
object.<member which references an FFUserGroup>

“none” means no one except the creator and “public” means every FFUser. Permissions may be combined in a comma-separated list.

For the methods available to the developer on the client-side, sample API documentation is attached in an Appendix A3.

Queries and Traversals

One of the reasons for incorporating a data model in an object model representation is to establish the relationships that can be programmatically traversed and queried. In and of themselves, query languages are not very interesting. There are many different ways of constructing queries using client- or server-side code. Because the system and method supports application development deployed to a web- and cloud-based platform, the structure of system and method's query language addresses: a) methods to create complex, nested constructions that can be sent over the wire in an efficient way; b) a consistent form of queries and traversals that is consistent across any client- or server-side programming language; and c) direct ways to take advantage of the datagraph, including particular system features in the NoServer embodiment, that can be created intuitively and easily using the system's query syntax.

The system query language, such as may be used by the NoServer module, is designed so that queries are part of HTTP GET request URIs. In that way, creating a query in one programming language, such as Objective-C, is identical to creating that query using another programming language, such as Java. The commands themselves are easy to understand, HTTP cache-friendly and can be issued as GET requests via cURL as well. There is no limit to how deeply queries can be nested nor to how complex the queries can be; even multi-layered, complex queries require little code to construct. This is the general form of a request URI that can be submitted using the system and method:

/<collection>/guid |

(<query>)/<traversal>/(<query>)/<traversal>/[&(<query>)|<traversal>...]

All queries begin on a collection. Either a specific guid from that collection is the starting point or a query is applied to the entire collection. Starting with a guid (e.g. often a specific FFUser in practice) is the most efficient way to begin a search, if performance is paramount.

Queries are processed from left to right. After each step, the resulting selection will be a set of objects or null. The next step in the query is applied to the previous selection set of objects.

Queries must be constructed within parentheses.

If a member name is used in a query, the value(s) of that member will be applied to the previous selection set in the query operation (e.g. /collection/(name eq ‘david’), name traverses that member called “name” of those object(s) in the collection).

Traversals reference a set of objects in a developer's datagraph. As with queries, traversals are applied to the set of objects returned in the previous step. Traversals must be a member of data-type REFERENCE or GRABBAG. Broadly, traversals allow the application developer to “move through” the datagraph.

The query syntax requires that a (<query>) and a <traversal> alternate: there may not be two of the same in a row. To apply traversals sequentially, use the empty query <Q> between them. The empty query selects all objects from the previous selection and passes them to the subsequent part of the request URI.

In the event that the final set of objects in a query would contain duplicate objects on the backend, the FatFractal platform deduplicates those results and returns only a single instance of an object.

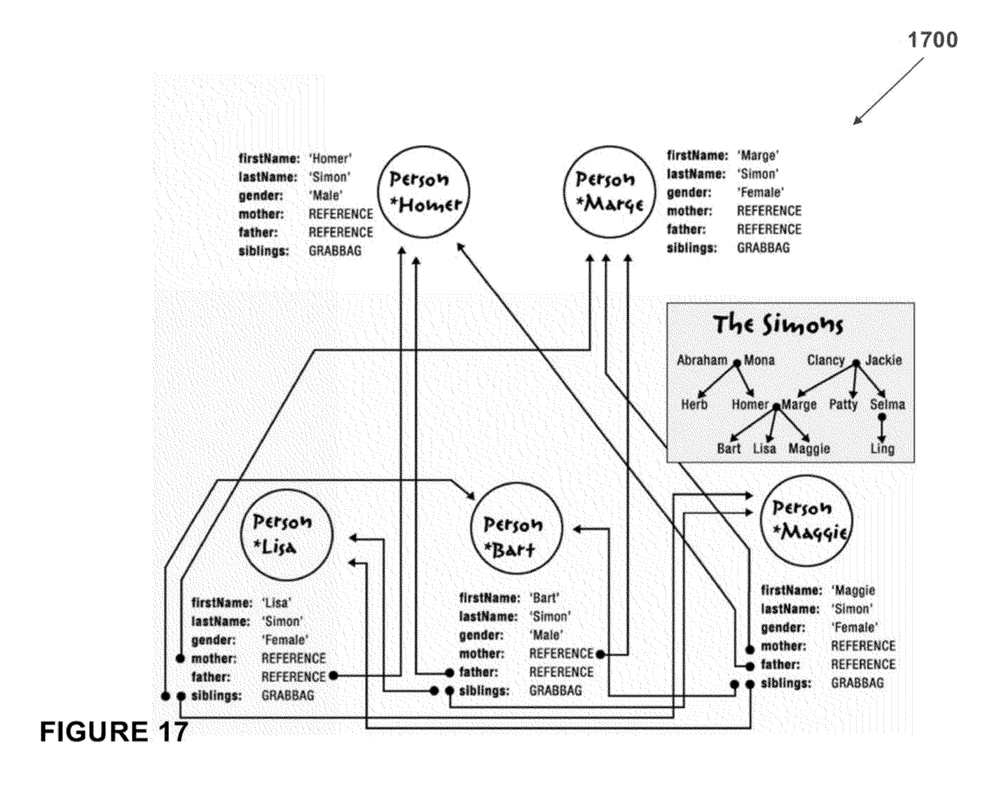

FIG. 17 illustrates a data model 1700 that might be represented in NoServer in an app's application.ffdl file as follows:

CREATE OBJECTTYPE Person (firstName STRING, lastName STRING, gender STRING, mother REFERENCE /Person, father REFERENCE /Person, siblings GRABBAG /Person)

Following this object-type definition, the Person object ‘Bart’ has firstName member of ‘Bart’, lastName member of ‘Simon’, gender member of ‘Male’, mother member a reference to a Person object, in this case, ‘Marge’, father a reference to a Person object, in this case, ‘Homer’ and a siblings member which is a grab bag of Person objects, in this case containing two objects, ‘Lisa’ and ‘Maggie’. The two members of type REFERENCE are incorporated directly as part of each Person object and are in that object's representation in the backend object architecture. The member of type GRABBAG is not incorporated directly into the object model. It is maintained separately in the backend object architecture as part of the _grab_bags list. The inset graphic called ‘The Simons’ is provided to refer to in some of the queries and traversals that follow.

The following are queries and traversals that a developer may use in application development on an embodiment, the FatFractal platform as well as the results derived from the datagraph in FIG. 17. In order to describe the use of the query language and options throughout the system, the first example illustrates a query as it would be implemented as REST calls, in Objective-C, Java and Javascript, as well as the case where the query must be to the application's backend and the case where the developer can interrogate a local object, for completeness.

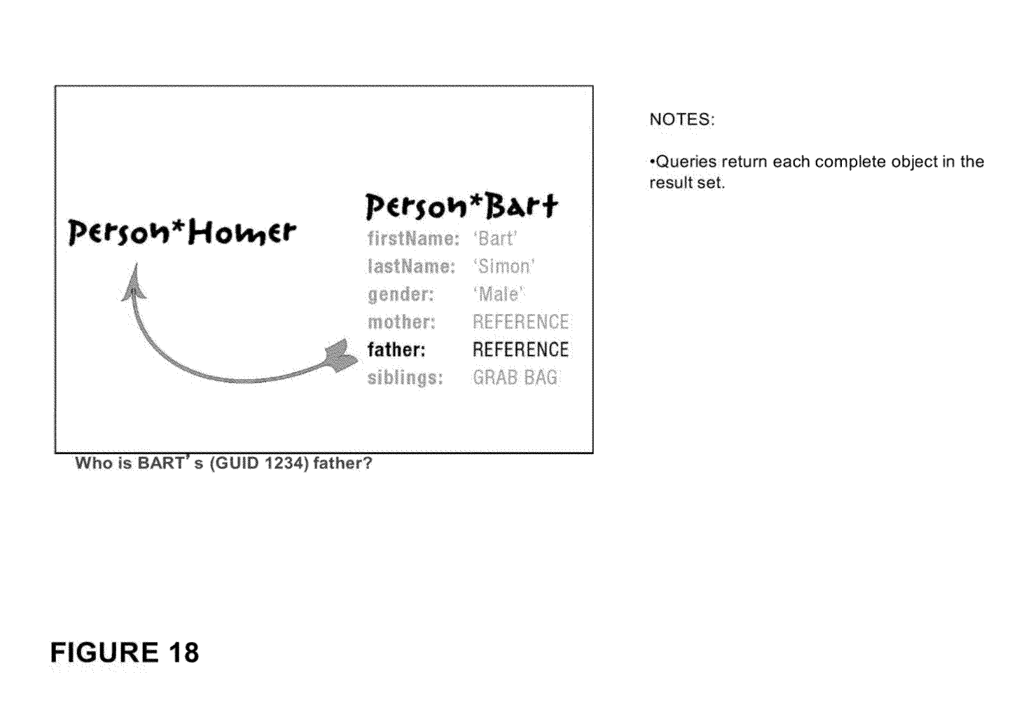

Who is Bart's father? [FIG. 18 Illustrates a Query on a REFERENCE Member]

The request URI for the query is, in each of the following cases, /Person/(firstName eq ‘Bart’)/father. The request is interpreted as follows: first retrieve all /Person objects where the firstName member is ‘Bart’. Then return the set of objects represented by the father member, which here is a REFERENCE to the /Person object, ‘homer’. The entire object is passed back in the response to the query.

REST
GET
http://acme.fatfractal.com/simpsonsfans/ff/resource/Person/(firstName
eq

′Bart′)/father

Objective-C (iOS)
//Retrieve directly from the application's backend
Person * homer = [ff getObjFromUri:@″/Person/(firstName
eq ′Bart′)/father″];
//If “bart” already exists on the client-side
Person * homer = [bart father];
Java (Android)
//Retrieve directly from the application's backend
Person homer = ff.getObjFromUri(″/Person/(firstName eq
′Bart′)/father″);
//If “bart” already exists on the client-side
Person homer = bart.father;
Javascript (client-side or server-side)
//Retrieve directly from the application's backend
var bart, homer;

ff.getObjFromUri(″/Person/(firstName eq ′Bart′)/father″,
function(response) {
homer = response;

});
//If ‘bart’ already exists on the client-side
homer = bart.father;

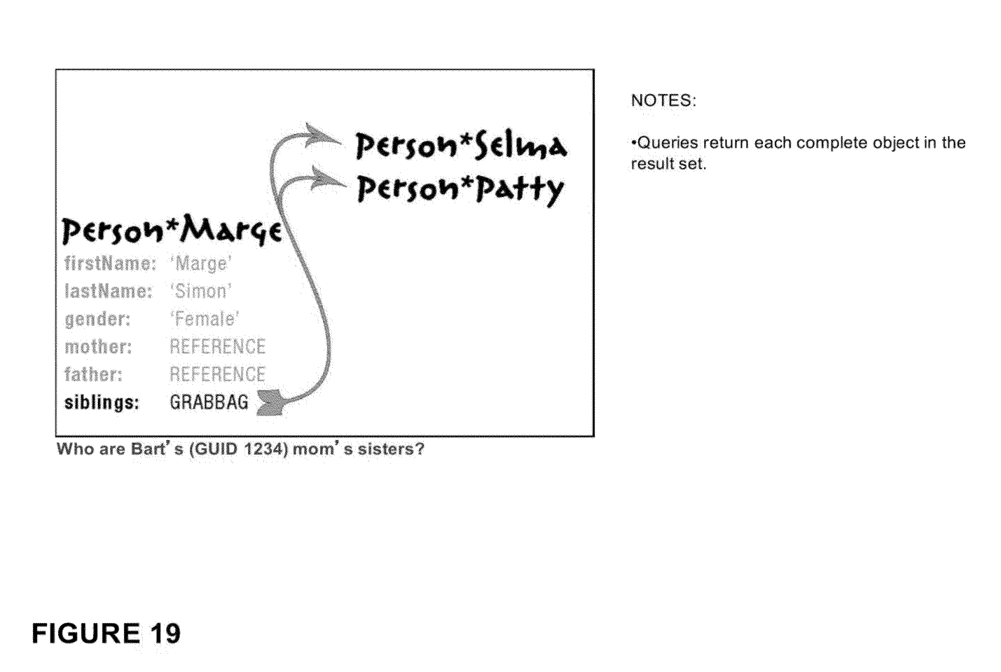

Who are Marge's sisters? [FIG. 19 Illustrates a Query on a GRABBAG Member]

Showing the request URI only, for simplicity. The request is interpreted as follows: start with the /Person object with guid ‘1234’, in this case the ‘bart’ object. Traverse the datagraph to the mother REFERENCE. The () operator indicates to pass forward the entire results of the previous step, namely the mother REFERENCE which is the ‘marge’ object. Traverse the datagraph to the siblings GRABBAG and pass forward those objects, in this case, the set of objects including the ‘selma’ /Person object and the ‘patty’ /Person object. Finally, apply the query to select from that set, only those objects where the gender member is ‘Female’. Since both objects meet the criterion, the set of two objects is passed back in the response to the query.

/Person/1234/mother/()/siblings/(gender eq ‘Female’)

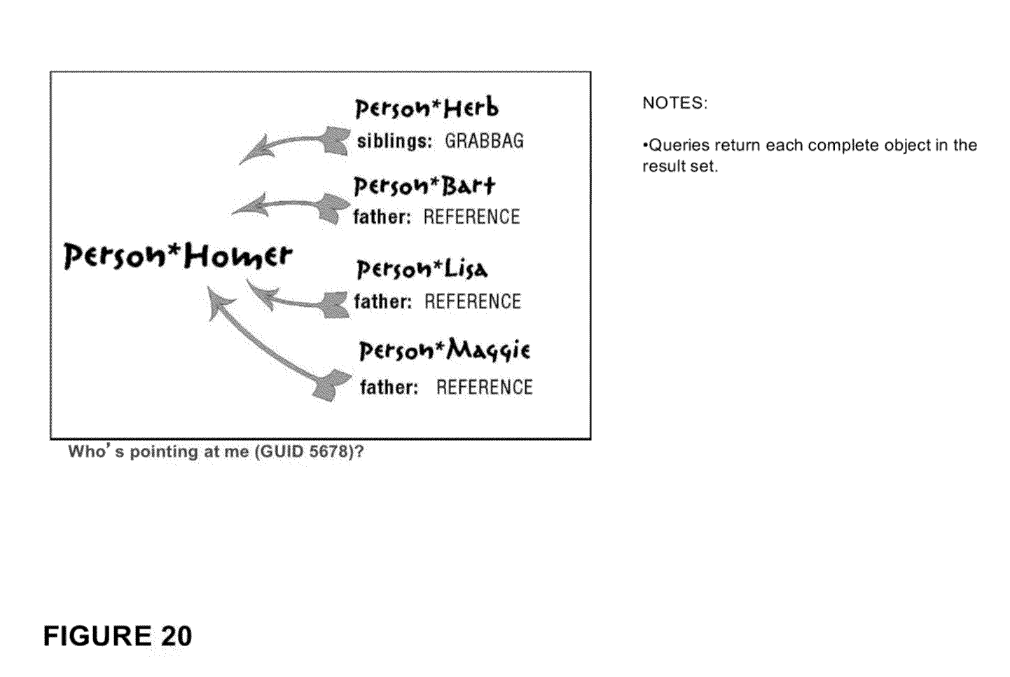

Who is pointing to Homer? [FIG. 20 a Query on a Back Reference]

Showing the request URIs only, for simplicity. As has been previously described, NoServer automatically creates and maintains back references for every object. These back references can be traversed across the datagraph “in reverse,” even though they a) were not explicitly created by the developer and b) are not explicitly represented as part of the developer's client-side object models. Because back references can be particularly useful to the application developer, a syntax has been provided so that these back reference traversals can be included directly and easily into the request URI.

Backreference traversal syntax:

/Collection/guid/BackReferences.Object_type_name.member_name

The BackReferences keyword indicates the traversal is to focus on the system-maintained grab bag called BackReferences referencing the specified guid. At the end of a query, the keyword ‘BackReferences’ will return the complete set of objects that have a back reference (i.e. “are pointing to”) referencing the object with the specified guid.

The Object_Type_name refers to the name of an object-type that exists.
The member_name must be part of the object-type specified and must be either of data-type REFERENCE or GRABBAG. That is, the member_name must be 0 or more indirect references which could “point to” the specified guid.

The following request with a back references traversal is interpreted as follows: Start with the Person object with guid ‘5678’, in this case, Homer. Traverse that object's back references. Since the request URI for the query stops at the keyword ‘BackReferences’, the set of all of those objects with any member of data-type REFERENCE or GRABBAG that references guid ‘5678’, will be passed back in the response to the query. In the case of the datagraph provided

/Person/5678/BackReferences

The following request gets all objects from the /Person collection which reference Homer as siblings, in this case {Herb}

/Person/5678/BackReferences.Person.siblings

The following request gets all objects from the /Person collection which reference Homer as father (bart, lisa, maggie) {Bart, Lisa, Maggie}

/Person/5678/BackReferences.Person.father

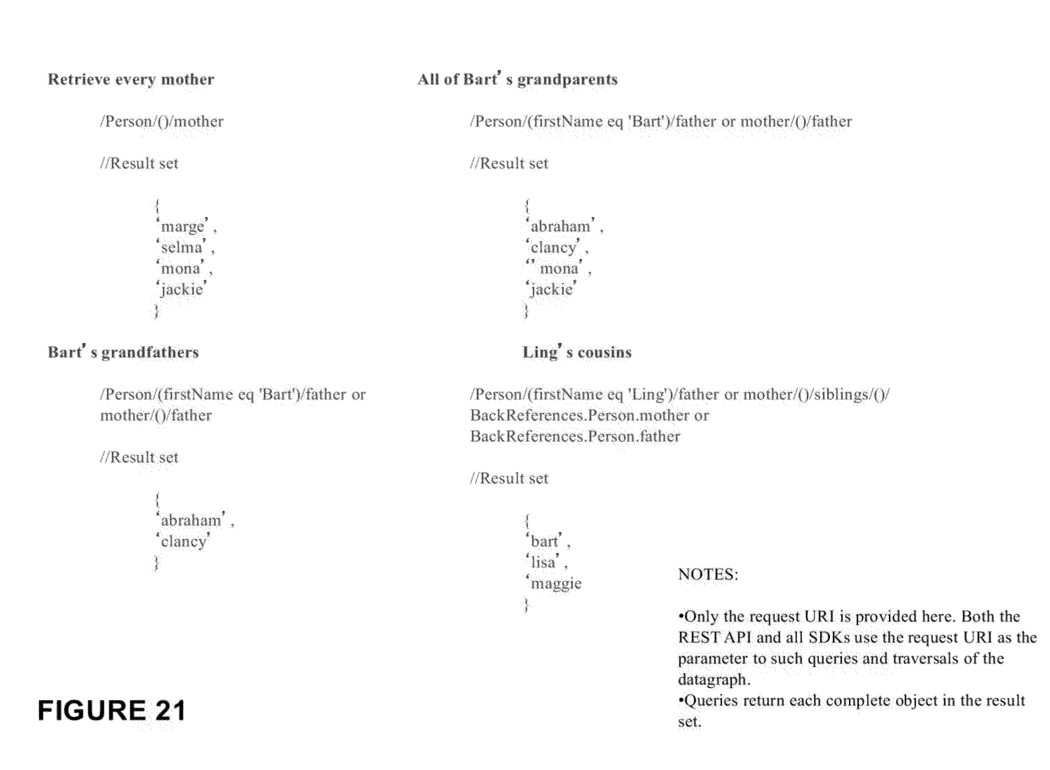

FIG. 21 illustrates a number of complex queries that a developer might make as well as the objects returned. A practitioner of the art will recognize that such complex queries are normally difficult to construct, often require multiple queries done sequentially to the backend and in the event they can be constructed at all, require a lot of code to manage effectively. NoServer handles that complexity on the backend.

While the foregoing has been with reference to a particular embodiment of the invention, it will be appreciated by those skilled in the art that changes in this embodiment may be made without departing from the principles and spirit of the disclosure, the scope of which is defined by the appended claims.

1. An application development platform, comprising:
one or more computing resources that host a backend system;
one or more connected devices that connect to the backend system;
each connected device having a memory that stores a plurality of lines of client side code of an application having a data model;
the backend system having a store that stores a plurality of lines of server side code of the application having the data model; and
the backend system having a backend state representation that instantiates an object model based on the data model, wherein the object model is shared across the client side code and the server side code.

2. The platform of claim 1, wherein the backend system has a GRABBAG backend data-type that is separate from the object model and stored by the backend system.

3. The platform of claim 2, wherein the GRABBAG data-type has a set of object pointers that point to one of one or more objects in a collection and any object from any collection.

4. The platform of claim 2, wherein the backend system automatically generates a back reference for each object in the object model, the back reference for a particular object containing a list of other objects that refer to the particular object.

5. The platform of claim 2, wherein the backend system further comprises an access control list for each object in the object model.

6. The platform of claim 2, wherein the backend system further comprises a query language that allows a user to traverse a datagraph associated with the object model.

7. The platform of claim 1, wherein default permission controls in the form of access control lists are defined as rules for all objects created in a collection.

8. The platform of claim 7, wherein the default permissions can be defined to be inherited from other objects that are referred to by the object model.

9. The platform of claim 1, wherein backend system is one of a cloud based system and a web based system.

10. The platform of claim 1, wherein each connected device is a processing unit based device that has one or more processing units, memory, a display and connectivity.

11. A method for developing an application, comprising:
providing a backend system and one or more connected devices that can connect to the backend system;
providing, in one of the connected devices, a plurality of lines of client side code of an application having a data model;
storing, in a store of the backend system, a plurality of lines of server side code of the application having the data model;
instantiating, in the backend system using a backend state representation, an object model based on the data model; and
sharing, by the backend system, the object model across the client side code and the server side code.

12. The method of claim 11 further comprising providing, by the backend system, a GRABBAG data-type that is separate from the object model and stored by the backend system.

13. The method of claim 12, wherein the GRABBAG data-type has a set of object pointers that point to one of one or more objects in a collection and any object from any collection.

14. The platform of claim 12 further comprising automatically generating, by the backend system, a back reference for each object in the object model, the back reference for a particular object containing a list of other objects that refer to the particular object.

15. The method of claim 12, wherein the backend system further comprises a default access control rule for each object in the object model.

16. The method of claim 12, wherein the backend further maintains an access control list for each object that can be programmatically changed by the client-side code or server-side code.

17. The method of claim 16, wherein the rule that defines the access control list for each object in the object model can be defined to be inherited from other objects that are referred to by the object model.

18. The method of claim 12 further comprising providing, by the backend system, a query language that allows a user to traverse a datagraph associated with the object model.

19. The method of claim 11, wherein backend system is one of a cloud based system and a web based system.
